(19) United States
(12) Patent Application Publication
(10) Pub. No.: US 2024/0282055 A1
(43) Pub. Date: Aug. 22, 2024

(54) MESH GPU CODEC FOR REAL-TIME STREAMING

(71) Applicant: QUALCOMM Incorporated, San Diego, CA (US)

(72) Inventors: Shraman Biswas, Atlanta, GA (US); Joseph Daniel GARVEY, San Diego, CA (US); Bojan VRCELJ, San Diego, CA (US)

(21) Appl. No.: 18/170,487

(22) Filed: Feb. 16, 2023

(51) Int. Cl. G06T 17/20; G06T 9/00

(52) U.S. Cl. CPC G06T 17/20; G06T 9/00

(57) ABSTRACT

This disclosure provides systems, devices, apparatus, and methods, including computer programs encoded on storage media, for a mesh GPU codec for real-time streaming. A graphics processor may obtain an indication of a compressed representation of a topology associated with at least one generalized triangle strip associated with a subset of triangles in a set of triangles. The graphics processor may obtain an intermediate representation of the topology associated with the at least one generalized triangle strip by a decompression of the compressed representation. The graphics processor may obtain a sequence of indices based on the intermediate representation of the topology associated with the at least one generalized triangle strip. The graphics processor may compute at least one set of offsets based on the intermediate representation. The graphics processor may reconstruct the set of triangles based on the sequence of indices and the at least one set of offsets.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for compressing and decompressing meshes may be associated with relatively large compressed content sizes and relatively long decompression times. There is a need for improved compression and decompression techniques for mesh representations of content.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and at least one processor coupled to the memory and, based at least in part on information stored in the memory, the at least one processor is configured to: obtain an indication of a topology associated with a mesh of a set of triangles; identify a set of triangle strips corresponding to the topology associated with the mesh; configure at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip; compute a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles; and output an indication of the compressed representation.

In an aspect of the disclosure, a method, a computer-readable medium, and an apparatus for graphics processing are provided. The apparatus includes a memory; and at least one processor coupled to the memory and, based at least in part on information stored in the memory, the at least one processor is configured to: obtain an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles; obtain an intermediate representation of the topology associated with the at least one generalized triangle strip by a decompression of the compressed representation; obtain the sequence of indices based on the intermediate representation of the topology associated with the at least one generalized triangle strip; compute at least one set of offsets based on the intermediate representation of the topology associated with the at least one generalized triangle strip; and reconstruct the set of triangles based on the sequence of indices and the at least one set of offsets, where the reconstructed set of triangles corresponds to a mesh of the set of triangles

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a GPU) in accordance with one or more techniques of this disclosure.

FIG. 3 illustrates an example image or surface in accordance with one or more techniques of this disclosure in accordance with one or more techniques of this disclosure.

FIG. 4 is a diagram illustrating various example aspects of a three dimensional (3D) mesh in accordance with one or more techniques of this disclosure.

FIG. 5 is a diagram illustrating various example aspects of a triangle list in accordance with one or more techniques of this disclosure.

FIG. 6 is a diagram illustrating various example aspects of triangle strips in accordance with one or more techniques of this disclosure.

FIG. 7 is a diagram illustrating various example aspects of generalized triangle strips in accordance with one or more techniques of this disclosure.

FIG. 8 is a diagram illustrating various example aspects of a generalized triangle strip sequence in accordance with one or more techniques of this disclosure.

FIG. 9 is a diagram illustrating various example aspects of a compact generalized triangle strip sequence in accordance with one or more techniques of this disclosure.

FIG. 10 is a diagram illustrating various example aspects of uncompacting indices in accordance with one or more techniques of this disclosure.

FIG. 11 is a diagram illustrating example threads used in a decoding process in accordance with one or more techniques of this disclosure.

FIG. 12 is a diagram illustrating various example aspects of computing first offsets in accordance with one or more techniques of this disclosure.

FIG. 13 is a diagram illustrating various example aspects of computing second offsets in accordance with one or more techniques of this disclosure.

FIG. 14 is a diagram illustrating various example aspects of computing third offsets in accordance with one or more techniques of this disclosure.

FIG. 15 is a diagram illustrating various example aspects of generating reconstructed triangles from a set of offsets and ordered indices in accordance with one or more techniques of this disclosure.

FIG. 16 is a call flow diagram illustrating example communications between an encoder and a decoder in accordance with one or more techniques of this disclosure.

FIG. 17 is a flowchart of an example method of graphics processing in accordance with one or more techniques of this disclosure.

FIG. 18 is a flowchart of an example method of graphics processing in accordance with one or more techniques of this disclosure.

FIG. 19 is a flowchart of an example method of graphics processing in accordance with one or more techniques of this disclosure.

FIG. 20 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or subcomponents of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

An application that is associated with the display of content having a relatively high level of geometric complexity may represent the content as meshes. Mesh representations may be associated with efficient culling, level-of-detail techniques, and procedural generation. A mesh representation may be characterized by a geometry and a topology. The topology may refer to a list of triangles, where each triangle may be described according to an ordered list of vertices. Due to the complexities involved in the topology, a CPU may compress the topology before transmitting the topology to a GPU and the GPU may decode the compressed topology in order to achieve faster content rendering in comparison to a GPU in that receives an uncompressed topology. Current techniques for topology compression may be associated with relatively large compression sizes and relatively long decode times. Furthermore, current techniques for topology compression may not be able to take advantage of multi-threaded CPU and/or GPU architectures. As such, current techniques for topology compression may not be fast enough for real-time applications.

Various technologies pertaining to a mesh codec for real time streaming are described herein. In an example, an encoder may obtain an indication of a topology associated with a mesh of a set of triangles. The encoder may identify a set of triangle strips corresponding to the topology associated with the mesh. A triangle strip may refer to a subset of triangles in a mesh with shared vertices. The encoder may configure at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip. The encoder may compute a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles. The encoder may output an indication of the compressed representation. In another example, a decoder may obtain an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles. The decoder may obtain an intermediate representation of the topology associated with the at least one generalized triangle strip by decompressing the compressed representation. The intermediate representation may be used to index a decompressed sequences of indices. In an example, the intermediate representation may be the result of an entropy encoding/decoding process. The decoder may obtain the sequence of indices based on the intermediate representation of the topology associated with the at least one generalized triangle strip. The decoder may compute at least one set of offsets based on the intermediate representation of the topology associated with the at least one generalized triangle strip. The decoder may reconstruct the set of triangles based on the sequence of indices and the at least one set of offsets, where the reconstructed set of triangles corresponds to a mesh of the set of triangles. The above-described technologies may be associated with various technological advantages, such as reduced storage sizes for compressed topologies and faster decoding times in comparison to other types of topology compression/decompression schemes. The above-described technologies may also be able to take advantage of multi-threaded CPU and/or GPU architectures.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

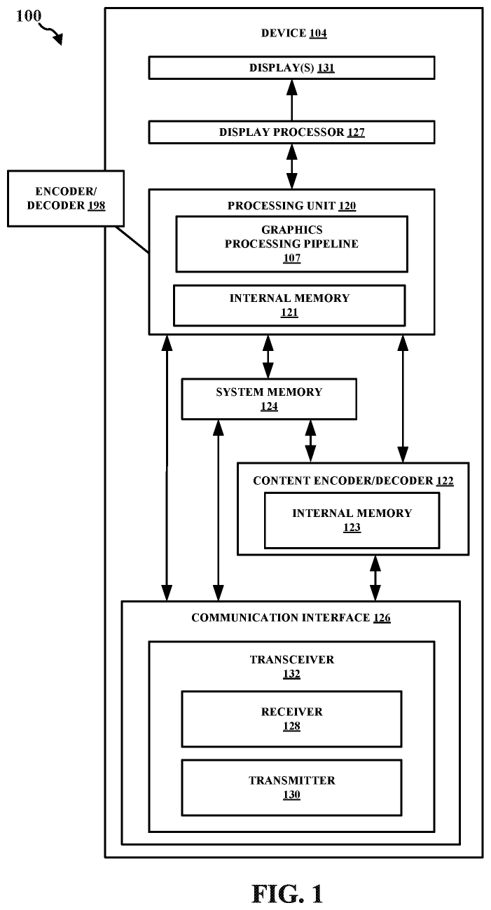

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an encoder/decoder 198 configured to obtain an indication of a topology associated with a mesh of a set of triangles; identify a set of triangle strips corresponding to the topology associated with the mesh; configure at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip; compute a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles; and output an indication of the compressed representation. In certain aspects, the encoder/decoder 198 is configured to obtain an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles; obtain an intermediate representation of the topology associated with the at least one generalized triangle strip by decompressing the compressed representation; obtain the sequence of indices based on the intermediate representation of the topology associated with the at least one generalized triangle strip; compute at least one set of offsets based on the intermediate representation of the topology associated with the at least one generalized triangle strip; and reconstruct the set of triangles based on the sequence of indices and the at least one set of offsets, where the reconstructed set of triangles corresponds to a mesh of the set of triangles. Although the following description may be focused on graphics processing, the concepts described herein may be applicable to other similar processing techniques. Similarly, although the following description may be focused on triangles, the concepts described herein may be applicable to other primitives as well, such as quadrilaterals (quads), convex polygons (n-gons), or concave polygons.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

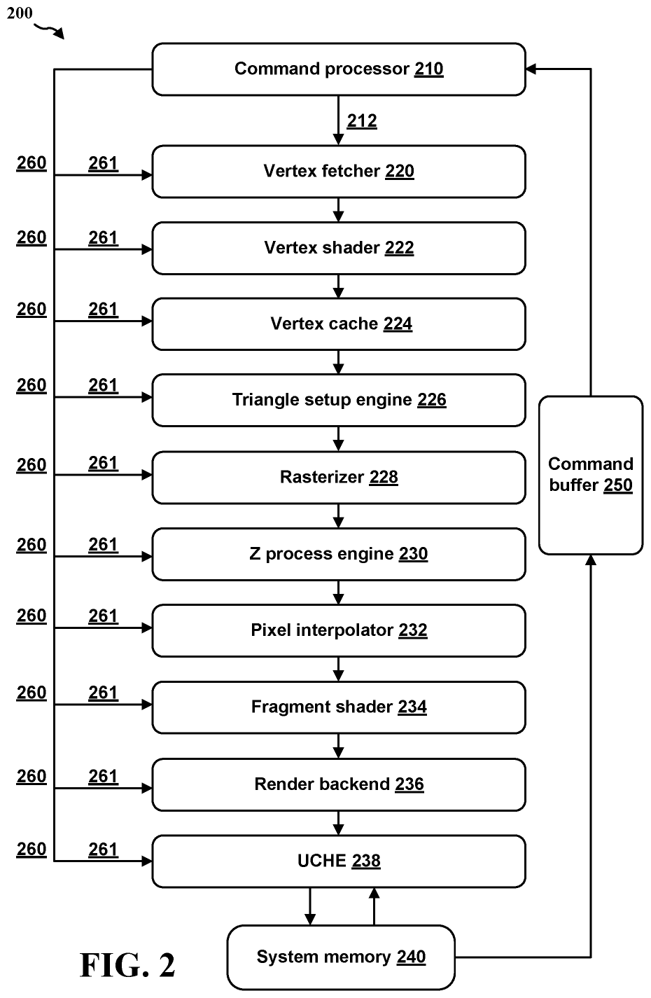

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may then be performed. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

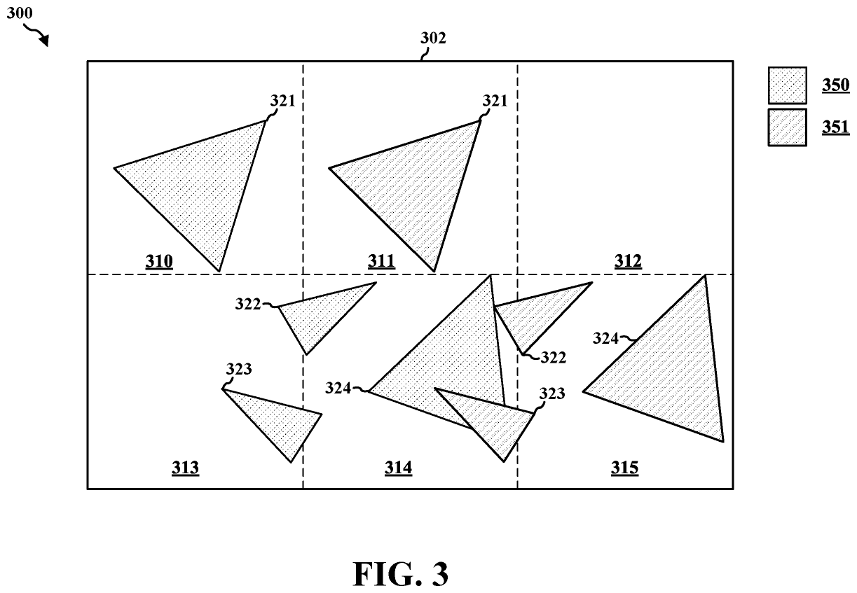

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

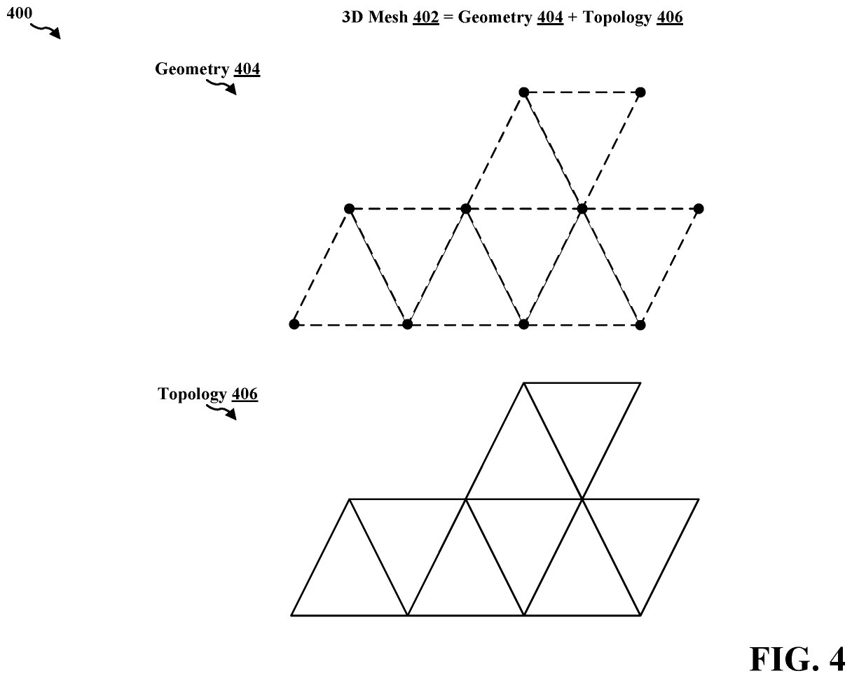

FIG. 4 is a diagram 400 illustrating various example aspects of a 3D mesh 402. The 3D mesh 402 may be characterized by a geometry 404 and a topology 406. The geometry 404 may be in the form of a point cloud. The point cloud may be associated with a list of vertices (depicted as darkened circles in the diagram 400). Vertices in the list of vertices may be floating-point data. The floating-point data may be compressed/decompressed with a lossy codec. In an example, a vertex may be characterized by an x-coordinate, a y-coordinate, and a z-coordinate: vertex: (x, y, z).

As noted above, the geometry 404 may be compressed using a lossy codec that utilizes position attributes (e.g., x, y, z) of the geometry 404. In an example, the floating-point data that represents the vertices may be in single-precision floating-point format (“float32”), that is, the floating-point data may include three float32s. In the example, the three float32s may be converted into three sixteen-bit unsigned integers (e.g., three uint16s) as part of a compression process.

The topology 406 may be associated with a list of triangles, where each triangle may be described according to an ordered list of vertices. The ordered list of vertices may include integer data. The integer data may be compressed/decompressed with a lossless codec. Lossless compression may refer to a compression process whereby a decompression process associated with the compression process restores an original representation of data without loss of the data. In an example, a triangle may be characterized by index A, index B, and index C: Triangle: {A, B, C}.

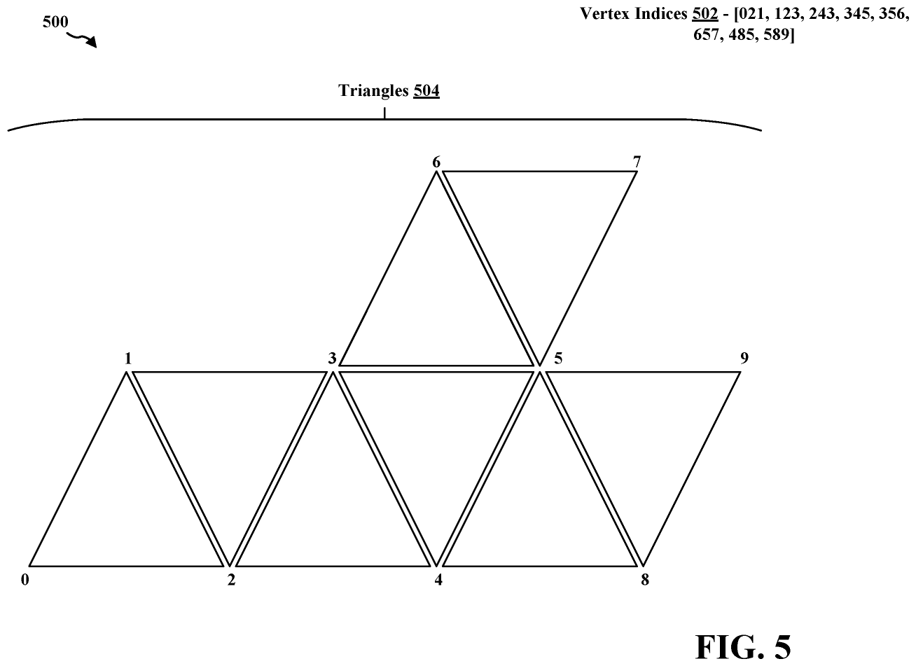

FIG. 5 is a diagram 500 illustrating various example aspects of a triangle list. As part of a topology compression process (lossless) for a 3D mesh (e.g., the 3D mesh 402), an encoder may obtain vertex indices 502 of triangles 504, where the vertex indices 502 include indices of vertices of triangles. In an example, the encoder may be a CPU. As depicted in the diagram 500, the triangles 504 include eight triangles. Vertex indices of the triangles are shown as numbers 0-9 in the diagram 500. In an example, the triangles 504 may be associated with graphical content that is to be rendered.

The vertex indices 502 may include one or more entries, where each entry represents a triangle. For instance, as depicted in the diagram 500, the vertex indices 502 may include [021, 123, 243, 345, 356, 657, 485, 589]. In an example, a first entry in the vertex indices 502 may be “021,” where the “0” in the first entry corresponds to vertex index 0 illustrated in the diagram 500 with respect to the triangles 504, the “2” in the first entry corresponds to vertex index 2 illustrated in the diagram 500 with respect to the triangles 504, and the “1” in the first entry corresponds to vertex index 1 illustrated in the diagram 500 with respect to the triangles 504.

In an example, an entry in the one or more entries of the vertex indices 502 may include three integers, where each integer may be represented by one byte (8-bits). For instance, in the first entry described above, “0” may be represented by a first byte, “2” may be represented by a second byte, and “1” may be represented by a third byte. In another example, each integer in the vertex indices 502 may be represented by more than one byte. In the example in the diagram 500, the vertex indices 502 include eight entries, and as such, a total size of the vertex indices 502 may be twenty-four bytes. More generally, a size of the vertex indices 502 may be 3×T, where T is a number of triangles. Furthermore, a size of a triangle strip (to be explained below) may be 2+T, where T is the number of triangles.

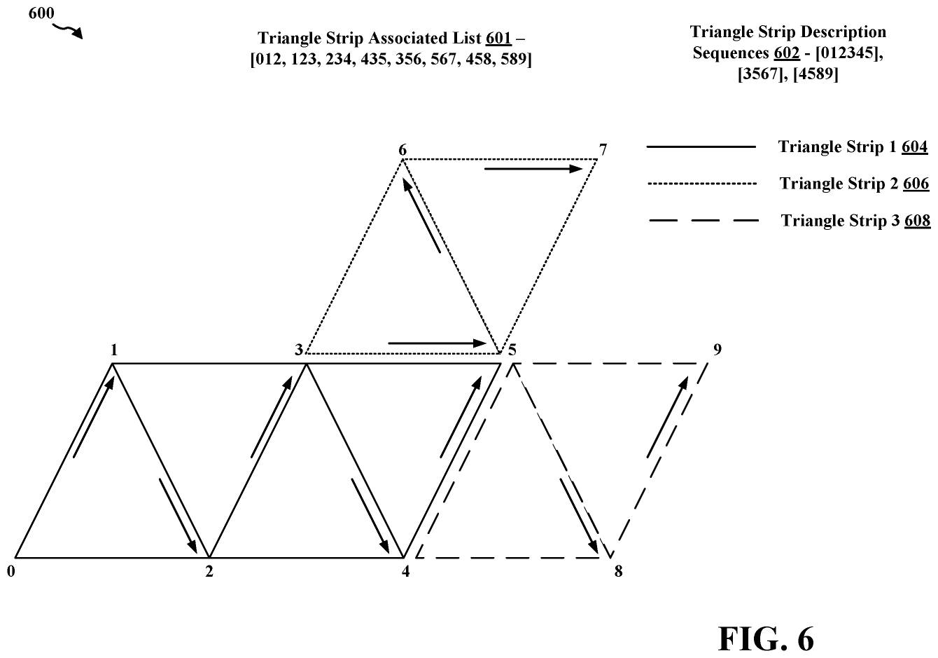

FIG. 6 is a diagram 600 illustrating various example aspects of triangle strips. As part of a topology compression process (lossless) for a 3D mesh (e.g., the 3D mesh 402), the encoder may identify a first triangle strip 604, a second triangle strip 606, and a third triangle strip 608, and the encoder may generate triangle strip description sequences 602 for the triangles 504. Each entry in the triangle strip description sequences 602 may represent a triangle strip. A triangle strip may refer to a subset of triangles in a mesh sharing vertices and edges, such that each subsequent triangle may be defined using a previous triangle by adding one vertex. Triangles in a triangle strip may be represented using an alternating ordering direction of indices (vertices): clockwise and counter-clockwise, such that the input list of triangles [021, 123, 243, 345, 356, 657, 485, 589] may be represented in a triangle strip associated list 601: [012, 123, 234, 435, 356, 567, 458, 589]. While a winding of faces in a mesh neighborhood may be the same (e.g., counterclockwise), when a mesh is represented as a triangle strip, the winding of the faces may be alternated. The distinction between odd and even triangle indices may facilitate a consistent orientation of all triangles. Thus, a single triangle strip may be represented by an ordered sequence of vertex indices without repetitions. Triangle strips may be useful in graphics for efficient rendering due to high vertex reuse between consecutive triangles. A graphics processor may keep the two common vertices between 2 consecutive triangles in memory before fetching the third (unique) vertex of the next triangle.

For instance, the encoder may generate a first triangle strip 604, a second triangle strip 606, and a third triangle strip 608 from the triangles 504. In an example, a first triangle strip description sequence in the triangle strip description sequences 602 may be [012345], where represents the first triangle strip 604. Each index within the first entry (e.g., 0, 1, 2, 3, 4, 5) may be represented by a byte (or more than one byte). Triangle strips may be associated with an encoding direction (depicted as arrows in the diagram 600). For instance, the first triangle strip 604 and the third triangle strip 608 may be associated with an encoding direction which starts as clockwise, and the second triangle strip 606 may be associated with an encoding direction which starts as counter-clockwise.

In a specific example, the encoder may traverse the indices of the triangles 504 in the following order as depicted in the diagram 500 in order to generate the first triangle strip 604: index 0 to index 1 to index 2 to index 3 to index 4 to index 5. In another specific example, the encoder may traverse the indices of the triangles 504 in the following order as depicted in the diagram 500 in order to generate the second triangle strip 606: index 3 to index 5 to index 6 to index 7. In a further specific example, the encoder may traverse the indices of the triangles 504 in the following order as depicted in the diagram 500 in order to generate the third triangle strip 608: index 4 to index 5 to index 8 to index 9.

The triangle strip description sequences 602 may be associated with a smaller size than the vertex indices 502. For instance, in the examples depicted in the diagram 500 and the diagram 600, the triangle strip description sequences 602 may have a size of fourteen bytes (e.g., six bytes for [012345], four bytes for [3567], and four bytes for [4589]) and the vertex indices 502 may have a size of twenty-four bytes. Thus, the triangle strip description sequences 602 may be a more compact way of storing information about the triangles 504.

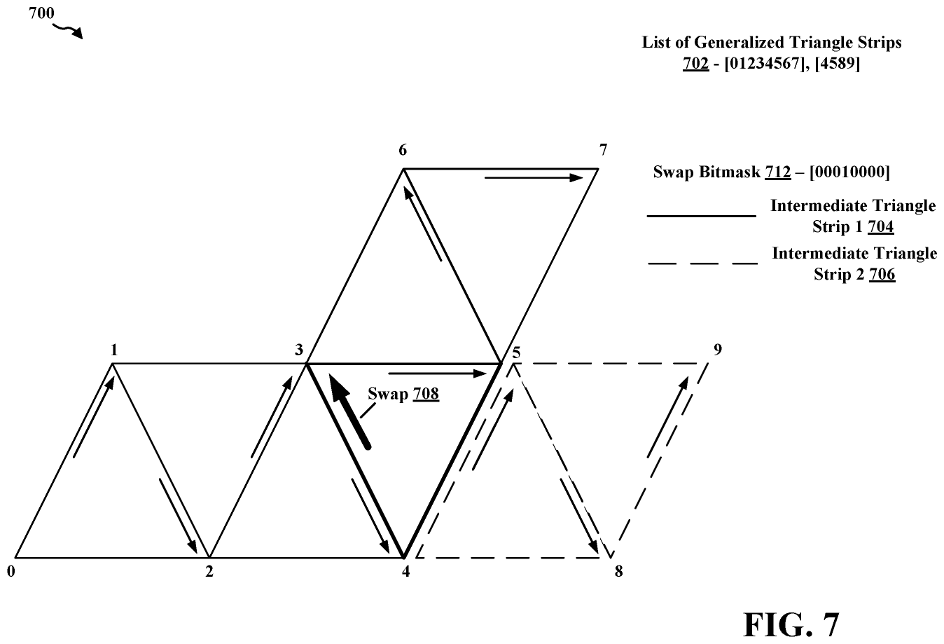

FIG. 7 is a diagram 700 illustrating various example aspects of generalized triangle strips. As part of a topology compression process (lossless) for a 3D mesh (e.g., the 3D mesh 402), the encoder may generate a list of generalized triangle strips 702 for the triangles 504. The list of generalized triangle strips 702 may also be referred to as “a list of generalized triangle strip description sequences.” Each entry in the list of generalized triangle strips 702 may represent a generalized triangle strip. A generalized triangle strip may be extension of the concept of triangle strips that covers an entirety of a mesh. A generalized triangle strip may include at least one swap (two consecutive triangles with vertices ordered in the same direction) and at least two restarts (triangles indicating beginnings of new triangle strips). A generalized triangle strip may include one or more triangle strips.

For instance, the encoder may begin generating a generalized triangle strip based on the first triangle strip 604, the second triangle strip 606, and the third triangle strip 608. In a first step, the encoder may combine the first triangle strip 604 and the second triangle strip 606 into a first intermediate triangle strip 704, leaving unjoined the third triangle strip 608 (which may now be referred to as a second intermediate triangle strip 706).

The encoder may generate a generalized triangle strip by performing a swap 708 of a direction of the encoding process described above. The swap 708 may correspond to a triangle. For example, as depicted in the diagram 700, the encoder may change the encoding of triangle 3 from a counter-clockwise encoding direction to a clockwise encoding direction (i.e., [435] instead of [345]) in order to incorporate both the first triangle strip 604 and the second triangle strip 606 into the first intermediate triangle strip 704. With more particularity, the encoder may traverse the indices of the triangles 504 in the following order as depicted in the diagram 700: index 0 to index 1 to index 2 to index 3 to index 4. Such traversal of indices may be consistent with the clockwise, counter-clockwise altering of the triangle windings in a triangle strip: [012, 123, 234]. In an example, the first and the second index of each triangle (starting from triangle 1 ([123])) may be equal to the second and third index respectively of the previous triangle in the list (in this example triangle 0 ([012])). However, as the swap 708 occurs with respect to triangle 3 the encoder may revisit index 3 after visiting index 4, leading to the first two indices in triangle 3 standing in reverse order, corresponding to the third and second index respectively of triangle 2 ([234]). This may lead to an overall order of indices for generating the first intermediate triangle strip 704: index 0 to index 1 to index 2 to index 3 to index 4 to index 3 to index 5 to index 6 to index 7.

A triangle at which the swap 708 occurs may be referred to as a swap triangle. The swap triangle may refer to place in a list of triangles in a triangle strip where the triangle index ordering is in the same direction (instead of alternating directions) between two consecutive triangles. In the example depicted in the diagram 700, the swap triangle may be triangle 3 (e.g., a triangle with vertex indices [345]. The encoder may compute a swap bitmask 712 (also referred to as a “Swap-Bitmask”) for the first intermediate triangle strip 704 based on the swap 708, where each bit in the swap bitmask 712 is associated with a triangle of the list of triangles 504 and where one or more bits in the swap bitmask 712 may be indicative of the swap 708. A bitmask may refer to a list of zeros and ones corresponding to a physical element, such as vertices or triangles.

In an example, a first entry of the list of generalized triangle strips 702 may be [01234567]. Each index in the first entry may be an integer that is represented by a byte. For instance, [01234567] may be eight bytes in length. The encoder may perform the swap 708, where the swap 708 may be associated with combining the first triangle strip 604 and the second triangle strip 606 into the first intermediate triangle strip 704. The encoder may generate (i.e., compute) the swap bitmask 712 based on the swap 708. The swap bitmask 712 may include a number of bits corresponding to a number of triangles indicated by the vertex indices 502. For instance, when generating the first entry of the list of generalized triangle strips 702, the encoder may generate the swap bitmask of length 6 bits, where bit number four is the “1” bit, corresponding to swap 708 occurring in triangle 3. In the example depicted in the diagram 700, the swap bitmask 712 is [00010000], where the last two “0” bits correspond to the last two triangles indicated in the vertex indices 502, which are represented by the second entry in the list of generalized triangle strips 702.

The list of generalized triangle strips 702 and the swap bitmask 712 may be associated with a smaller size than the triangle strip description sequences 602. For instance, in the examples depicted in the diagram 600 and the diagram 700, the list of generalized triangle strips 702 and the swap bitmask 712 may have a size of thirteen bits (e.g., eight bytes for [01234557], four bytes for [4589], and one byte for the swap bitmask 712) and the triangle strip description sequences 602 may have a size of fourteen bytes. Furthermore, the list of generalized triangle strips 702 may include indices for two intermediate triangle strips while the triangle strip description sequences 602 may include indices for three triangle strips. Thus, the list of generalized triangle strips 702 may be a more compact way of storing information about the triangles 504.

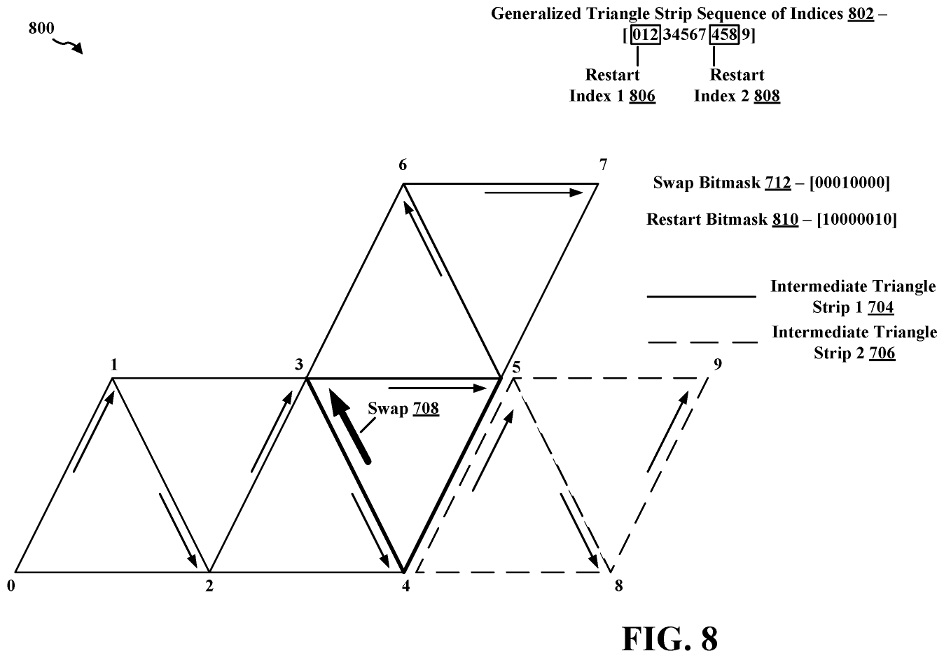

FIG. 8 is a diagram 800 illustrating various example aspects of a generalized triangle strip sequence. As part of a topology compression process (lossless) for a 3D mesh (e.g., the 3D mesh 402), the encoder may generate a generalized triangle strip sequence of indices 802 for the triangles 504 based on the list of generalized triangle strips 702. For instance, the encoder may combine the first entry ([01234567]) and the second entry ([4589]) of the list of generalized triangle strips 702 to generate the generalized triangle strip sequence of indices 802 ([012345674589]). The generalized triangle strip sequence of indices 802 (which may also be referred to as the generalized triangle strip sequence) may include the swap triangle (associated with the swap bitmask 712) described above.

The generalized triangle strip sequence of indices 802 may include a first restart index 806 and a second restart index 808, where the first restart index 806 corresponds to a start of the first intermediate triangle strip 704 and where the second restart index 808 corresponds to a start of the second intermediate triangle strip 706 (i.e., a remaining triangle strip). A restart index may refer to a starting triangle on an individual triangle strip in a list of intermediate triangle strips. The first restart index 806 and the second restart index 808 may also be referred to as “the first start index” and “the second start index,” respectively. The encoder may generate a restart bitmask 810 (also referred to as a “Restart-Bitmask”) to represent the start of the first intermediate triangle strip 704 and the start of the second intermediate triangle strip 706. Each bit in the restart bitmask 810 may be associated with one of the triangles 504—namely a first triangle in each intermediate triangle strip in the list of generalized triangle strips 702.

In an example, the restart bitmask 810 may be [10000010]. The “1” bit at a first bit position (i.e., a zero index) in the restart bitmask 810 may indicate that the first intermediate triangle strip 704 starts with vertex index 0 and the “1” bit at the seventh bit position in the restart bitmask 810 may indicate that the second intermediate triangle strip 706 starts with vertex index 4.

The generalized triangle strip sequence of indices 802, the swap bitmask 712, and the restart bitmask 810 may be associated with a smaller size than the vertex indices 502. For instance, in the examples depicted in the diagram 500 and the diagram 800, the generalized triangle strip sequence of indices 802, the swap bitmask 712, and the restart bitmask 810 may have a size of fourteen bytes (e.g., twelve bytes for [012345674589], one byte for the swap bitmask 712, and one byte for the restart bitmask 810) and the vertex indices 502 may have a size of twenty-four bytes. Thus, the generalized triangle strip sequence of indices 802, the swap bitmask 712, and the restart bitmask 810 may be a more compact way of storing information about the triangles 504.

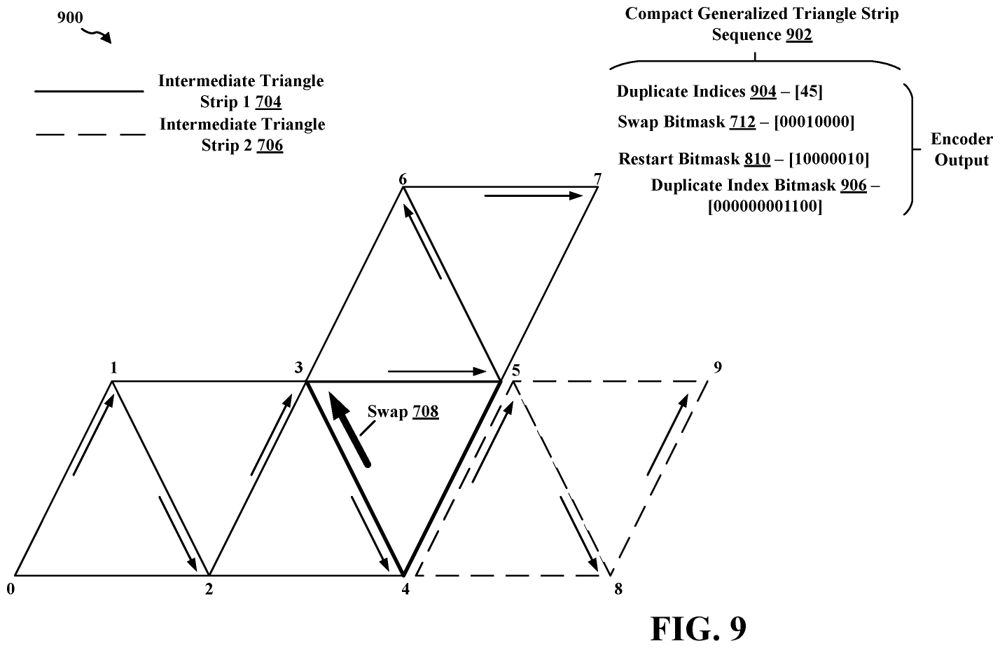

FIG. 9 is a diagram 900 illustrating various example aspects of a compact generalized triangle strip sequence. As part of a topology compression process (lossless) for a 3D mesh (e.g., the 3D mesh 402), the encoder may generate a compact generalized triangle strip sequence 902. The compact generalized triangle strip sequence 902 may include the swap bitmask 712 and the restart bitmask 810 as described above.

The compact generalized triangle strip sequence 902 may also include duplicate indices 904 (which may also be referred to as “Duplicate-Indices”) and a duplicate index bitmask 906 (which may also be referred to as an index bitmask, or an “Index-Bitmask”). The duplicate indices 904 may include indices that are shared between the first intermediate triangle strip 704 and the second intermediate triangle strip 706. In an example, the first intermediate triangle strip 704 and the second intermediate triangle strip 706 may share index 4 and index 5. As such, the duplicate indices 904 may be [45]. Each index in the duplicate indices 904 may be represented by a byte.

The duplicate index bitmask 906 may include bits corresponding to the first intermediate triangle strip 704 and the second intermediate triangle strip 706. In an example, the duplicate index bitmask 906 is [000000001100]. The first eight “0” bits in the duplicate index bitmask 906 may correspond to the first intermediate triangle strip 704. The following “1100” bits may correspond to the second intermediate triangle strip 706. The “11” bits may indicate that the first intermediate triangle strip 704 and the second intermediate triangle strip 706 share two indices. In an example, the first “1” bit in the duplicate index bitmask 906 may correspond to index 4 in the duplicate indices 904 and the second “1” bit in the duplicate index bitmask 906 may correspond to index 5 in the duplicate indices 904.

The encoder may output the compact generalized triangle strip sequence 902 (including the duplicate indices 904, the swap bitmask 712, the restart bitmask 810, and the duplicate index bitmask 906) for a decoder. The compact generalized triangle strip sequence 902 may be associated with a smaller size than the vertex indices 502, the triangle strip description sequences 602, the list of generalized triangle strips 702, and/or the generalized triangle strip sequence of indices 802. For instance, the compact generalized triangle strip sequence 902 may have a size of 5.5 bytes (e.g., two bytes for the duplicate indices 904, one byte for the swap bitmask 712, one byte for the restart bitmask 810, and 1.5 bytes for the duplicate index bitmask 906). In some aspects, the duplicate indices 904, the swap bitmask 712, the restart bitmask 810, and the duplicate index bitmask 906 may be treated as bitstreams in scenarios involving a relatively large mesh.

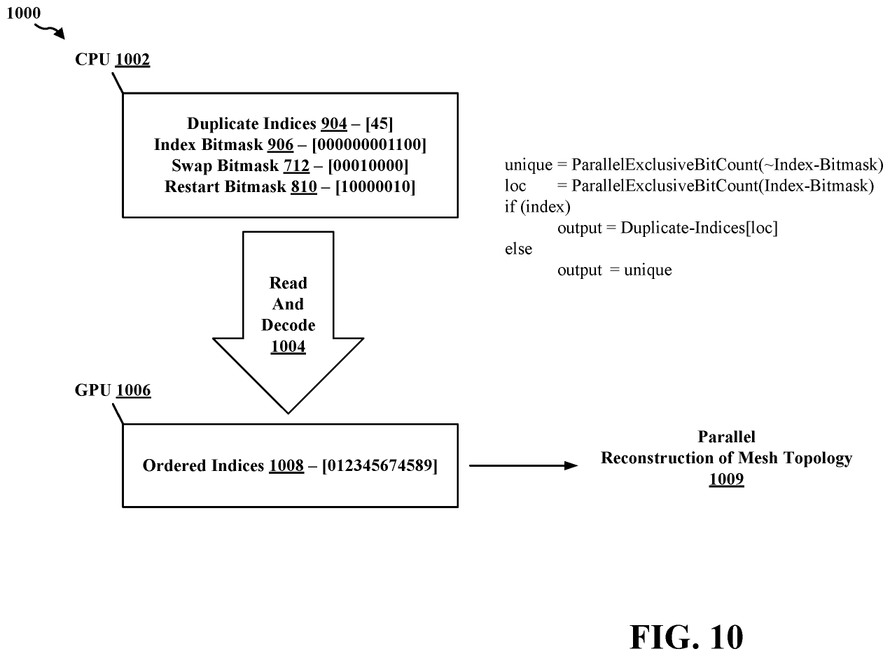

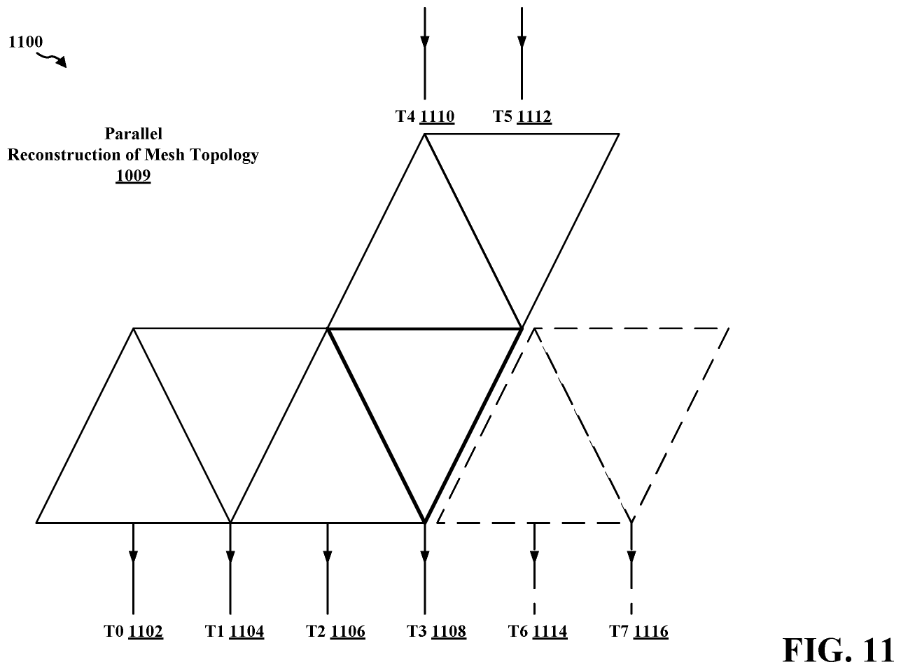

FIG. 10 is a diagram 1000 illustrating various example aspects of uncompacting indices as part of a topology decompression process (lossless) for a 3D mesh (e.g., the 3D mesh 402). A CPU 1002 (i.e., an encoder) may generate the duplicate indices 904, the duplicate index bitmask 906, the swap bitmask 712, and the restart bitmask 810 as described above in the description of FIG. 9. Through a read and decode process 1004 (e.g., a parallel read and decode process), a GPU (i.e., a decoder) may generate ordered indices 1008 based upon the duplicate indices 904 and the duplicate index bitmask 906. The GPU (i.e., a decoder) may perform a parallel reconstruction of mesh topology 1009 using the ordered indices 1008, the swap bitmask 712, and the restart bitmask 810, which may lead to a decoded list of triangles. Aspects of the parallel reconstruction of the mesh topology 1009 are described in greater detail below in the description of FIGS. 11-15.

An example of the read and decode process 1004 is now set forth. Although the GPU 1006 may process each bit of the duplicate index bitmask 906 in parallel, the explanation below will be focused on sequentially processing each bit for ease of explanation. The duplicate indices 904 may be [45] and the duplicate index bitmask 906 may be [000000001100].

The GPU 1006 (i.e., a decoder) may generate the ordered indices 1008, where the ordered indices 1008 may is a sequence of a same length of the duplicate index bitmask 906. For example, the duplicate index bitmask 906 may include 12 bits and the ordered indices 0108 may include 12 integers. For instance, the GPU 1006 may use mask “0” bits in the duplicate index bitmask 906 to indicate that corresponding integers are to be obtained from incrementation, starting from zero, and the GPU 1006 may use mask “1” bits in the duplicate index bitmask 906 as instructions to copy indices from the duplicate indices 904 in such places.

The read and decode process 1004 may be performed via the following pseudocode listed below.

| | |
|---|---|
| unique | = ParallelExclusiveBitCount(~Index-Bitmask) |
| loc | = ParallelExclusiveBitCount(Index-Bitmask) |

if (index)

output = Duplicate-Indices[loc]

else

output = unique

FIG. 11 is a diagram 1100 illustrating example threads used in a decoding process. The threads may be utilized as part of a topology decompression process (lossless) for a 3D mesh (e.g., the 3D mesh 402). In an example, the parallel reconstruction of the mesh topology 1009 may utilize the threads. The diagram 1100 depicts a first thread 1102 (depicted as “T0” in FIG. 11 to correspond to triangle 0), a second thread 1104 (depicted as “T1” in FIG. 11 to correspond to triangle 1), a third thread 1106 (depicted as “T2” in FIG. 11 to correspond to triangle 2), a fourth thread 1108 (depicted as “T3” in FIG. 11 to correspond to triangle 3), a fifth thread 1110 (depicted as “T4” in FIG. 11 to correspond to triangle 4), a sixth thread 1112 (depicted as “T5” in FIG. 11 to correspond to triangle 5), a seventh thread 1114 (depicted as “T6” in FIG. 11 to correspond to triangle 6), and an eighth thread 1116 (depicted as “T7” in FIG. 11 to correspond to triangle 7). The first thread 1102, the second thread 1104, the third thread 1106, the fourth thread 1108, the fifth thread 1110, the sixth thread 1112, the seventh thread 1114, and the eighth thread 1116 may be collectively referred to as “a plurality of threads 1102-1116.” A thread may refer to a relatively small subset of instructions designed to be scheduled and executed by a compute unit (e.g., a GPU, CPU, etc.) independently of a parent process and other threads. In an example, the plurality of threads 1102-1116 may be GPU threads.

Each thread in the plurality of threads 1102-1116 may decode one triangle in the triangles 504. In an example, a thread in the plurality of threads 1102-1116 may compute three index offsets (C, B, A) based on the ordered indices 1008, the restart bitmask 810, and the swap bitmask 712. Index offsets may be random and/or may overlap. As will be described in greater detail below, a GPU may compute index offsets in a manner that minimizes cross-thread communication. The thread may produce three indices {I_{C}, I_{B}, I_{A}} based on the three index offsets, where the three indices {I_{C}, I_{B}, I_{A}} may correspond to a triangle in the triangles 504. Stated differently, the thread may decode a triangle. The triangle may be rendered using the three indices {I_{C}, I_{B}, I_{A}}.

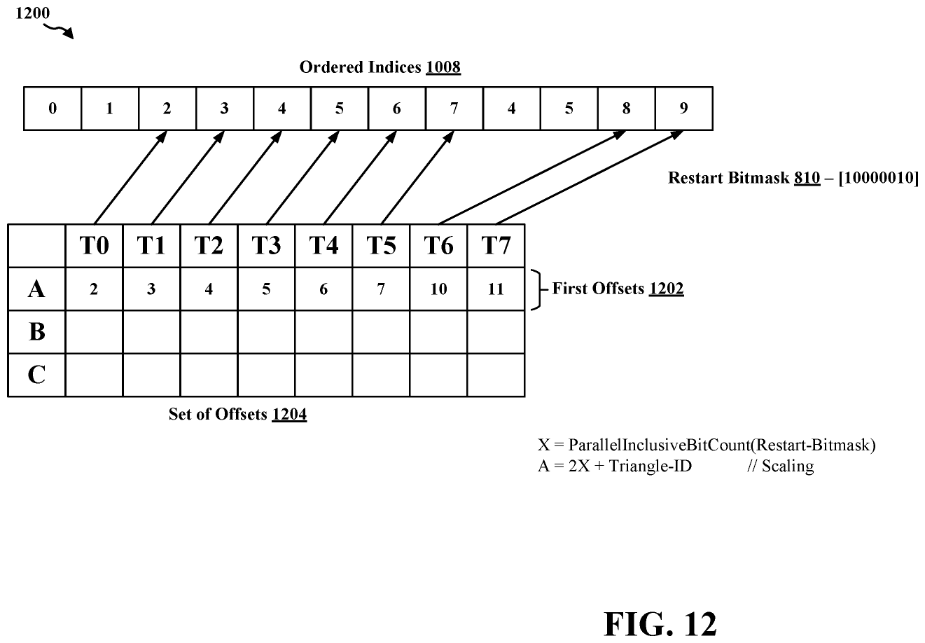

FIG. 12 is a diagram 1200 illustrating various example aspects of computing first offsets 1202. The first offsets 1202 may be included in a set of offsets 1204 that may be utilized to reconstruct the triangles 504 as part of a topology decoding process (lossless) for a 3D mesh (e.g., the 3D mesh 402). A decoder (e.g., a GPU) may compute the first offsets 1202 based on the restart bitmask 810 (described above). The first offsets 1202 may be associated with a scaling operation. In the diagram 1200, integers (i.e., indices) in the row including “A” may correspond to the first offsets 1202. Furthermore, in the diagram 1200 (and in subsequent diagrams), T0-T7 respectively correspond to triangle identifiers (also referred to as “Triangle-ID”). In an example, TO may refer to a Triangle-ID of 0, T1 may refer to a Triangle-ID of 1, T2 may refer to a Triangle-ID of 2, and so forth. Furthermore, TO may be associated with the first bit of the swap bitmask 712 and the restart bitmask 810, T1 may be associated with the second bit of the swap bitmask 712 and the restart bitmask 810, etc. Additionally, in the diagram 1200, the arrows may depict relationships between each of the first offsets 1202 and the ordered indices 1008.

The decoder may generate the first offsets 1202 according to the pseudocode below.

$$X = ParellelInclusiveBitCount ( Restart ‐ Bitmask ) \\ A = 2 X + Triangle ‐ ID$$

In the pseudocode listed above, ParallelInclusiveBitCount(Restart-Bitmask) may return a cumulative number of “1” bits in the restart bitmask 810 from a beginning of the restart bitmask 810 to a current index of the restart bitmask 810. Example computations of selected offsets in the first offsets 1202 are now set forth when the restart bitmask 810 is [10000010]. For A:T0, ParallelInclusiveBitCount(Restart-Bitmask) may generate a “1” integer, as the zero index of the restart bitmask 810 includes a “1” bit and hence at the zero index of the restart bitmask 810, the number of “1” bits is one. Furthermore, the Triangle-ID for TO may be 0. As such, the offset for A:T0 may be A=2(1)+0=2. For A:T1, ParallelInclusiveBitCount(Restart-Bitmask) may generate a “1” integer, as the zero index of the restart bitmask 810 includes a “1” bit and the first index of the restart bitmask 810 includes a “0” bit, thus there remains a total of one “1” bit in the restart bitmask 810 up to an including the first index of the restart bitmask 810. Furthermore, the Triangle-ID for T1 may be 1. As such, the offset for A:T1 may be A=2(1)+1=3. For A:T6, ParallelInclusiveBitCount(Restart-Bitmask) may generate a “2” integer, as the zero index of the restart bitmask 810 includes a “1” bit, indices one through five of the restart bitmask 810 include “0” bits, and the sixth index of the restart bitmask 810 includes a “1” bit, thus there is a total of two “1” bits in the restart bitmask 810 up to and including the sixth index. Furthermore, the Triangle-ID for T6 may be 6. As such, the offset for A:T6 may be A=2(2)+6=10.

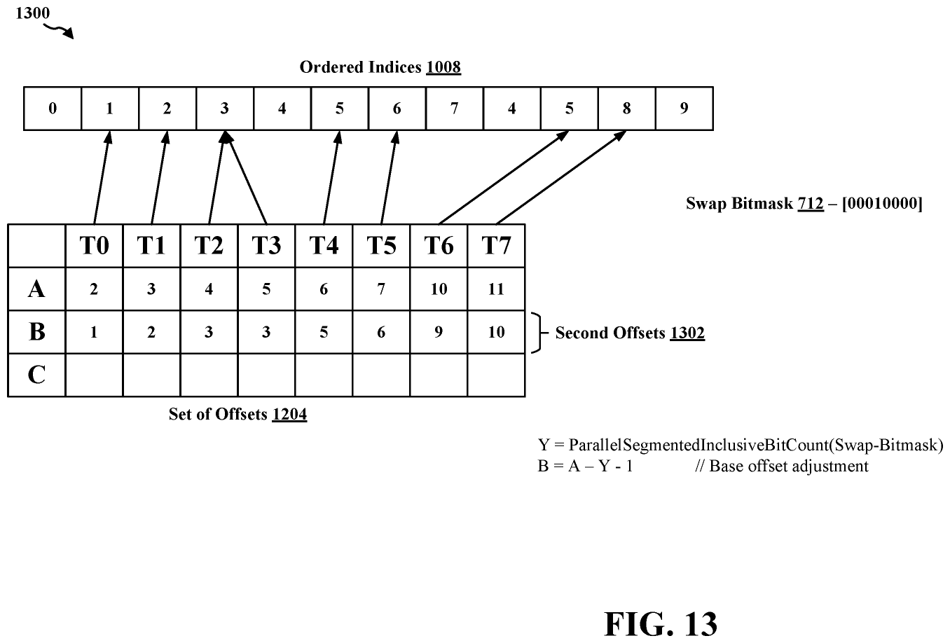

FIG. 13 is a diagram 1300 illustrating various example aspects of computing second offsets 1302. The second offsets 1302 may be included in the set of offsets 1204 that may be utilized to reconstruct the triangles 504 as part of a topology decoding process (lossless) for a 3D mesh (e.g., the 3D mesh 402). A decoder (e.g., a GPU) may compute the second offsets 1302 based on the swap bitmask 712 (described above). The first offsets 1202 may be associated with a base offset adjustment. In the diagram 1200, integers (i.e., indices) in the row including “B” may correspond to the second offsets 1302. Additionally, in the diagram 1300, the arrows may depict relationships between each of the second offsets 1302 and the ordered indices 1008.

The decoder may generate the second offsets 1302 according to the pseudocode below.

$$Y = ParallelSegmentedInclusiveBitCount ( Swap ‐ Bitmask ) \\ B = A - Y - 1$$

In the pseudocode listed above, ParallelSegmentedInclusiveBitCount(Swap-Bitmask) may increment the current counter when a bit at the current index is “1” and may reset the current counter to zero when a bit at the current index is “0”. In other words, the operation may return the number of consecutive “1” bits leading up to the current location. Example computations of selected offsets in the second offsets 1302 are now set forth when the swap bitmask 712 is [00010000]. For B:T0, ParallelSegmentedInclusiveBitCount(Swap-Bitmask) may return a “0” integer, as the bit at index zero of the swap bitmask 712 is a “0” bit. Furthermore, for B:T0, A (i.e., an offset in the first offsets 1202) may be 2 (described above in the description of FIG. 12). As such, the offset for B:T0 may be B=2−0−1=1. For B:T1, ParallelSegmentedInclusiveBitCount(Swap-Bitmask) may return a “0” integer, as the bit at index one of the swap bitmask 712 is a “0” bit. Furthermore, for B:T1, A (i.e., an offset in the first offsets 1202) may be 3 (described above in the description of FIG. 12). As such, the offset for B:T1 may be B=3−0−1=2. For B:T3, Parallel SegmentedInclusiveBitCount(Swap-Bitmask) may return a “1” integer, as the bit at index three of the swap bitmask 712 may be a “1” bit, and the bit at index two of the swap bitmask 712 may be a “0” bit. Furthermore, for B:T3, A (i.e., an offset in the first offsets 1202) may be 5. As such, the offset for B:T3 may be B=5−1−1=3.

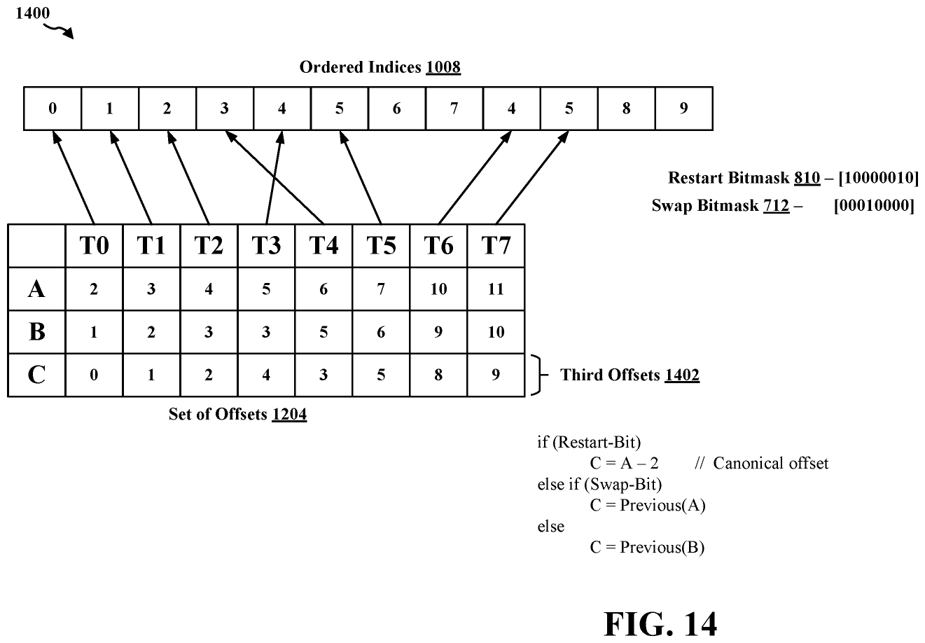

FIG. 14 is a diagram 1400 illustrating various example aspects of computing third offsets 1402. The third offsets 1402 may be included in the set of offsets 1204 that may be utilized to reconstruct the triangles 504 as part of a topology decoding process (lossless) for a 3D mesh (e.g., the 3D mesh 402). A decoder (e.g., a GPU) may compute the third offsets 1402 based on the first offsets 1202, the second offsets 1302, the swap bitmask 712, and the restart bitmask 810 (described above). The third offsets 1402 may be associated with a canonical offset. In the diagram 1400, integers (i.e., indices) in the row including “C” may correspond to the third offsets 1402. Additionally, in the diagram 1400, the arrows may depict relationships between each of the third offsets 1402 and the ordered indices 1008.

The decoder may generate the third offsets 1402 according to the pseudocode below.

```
if (Restart-Bit)
  C = A − 2
else if (Swap-Bit)
  C= Previous(A)
else
  C = Previous(B)
```

The decoder may generate the third offsets 1402 by evaluating the restart bitmask 810 and/or the swap bitmask 712 at the same index. If a bit in the restart bitmask 810 is a “1” bit, an offset in the third offsets 1402 may be computed as C=A−2. If the bit in the restart bitmask 810 is a “0” bit, and a bit in the swap bitmask 712 is a “1” bit, the offset in the third offsets 1402 may be computed as C=Previous(A), where Previous(A) may be a value for A for the triangle that is immediately previous to the triangle currently being evaluated. In one example, when T3 is being evaluated, Previous(A) may be A:T2=4. If the restart bitmask 810 and the swap bitmask 712 both include “0” bits at the same index, the offset in the third offsets 1402 may be computed as C=Previous(B), where Previous (B) may be a value for B for the triangle that is immediately previous to the triangle currently being evaluated. For example, when T2 is being evaluated, Previous(B) is B:T1=2.

Example computations of selected offsets in the third offsets 1402 are now set forth when the restart bitmask 810 is [10000010] and the swap bitmask 712 is [00010000]. For C:T0, the zero index of the restart bitmask 810 may include a “1” bit and A:T0 may be 2 (described above). As such, the offset for C:T0 may be C=2−2=0. For C:T1, the first index of the restart bitmask 810 may include a “0” bit and the first index of the swap bitmask 712 may include a “0” bit. Furthermore, a previous value of B (i.e., B:T0) may be 1. As such, the offset for C:T1 may be C=Previous(B)=B:T0=1. For C:T3, the third index of the restart bitmask 810 may include a “0” bit and the third index of the swap bitmask 712 may include a “1” bit. Furthermore, a previous value of A (i.e., A:T2) may be 4. As such, the offset for C:T3 may be C=Previous(A)=A:T2=4.

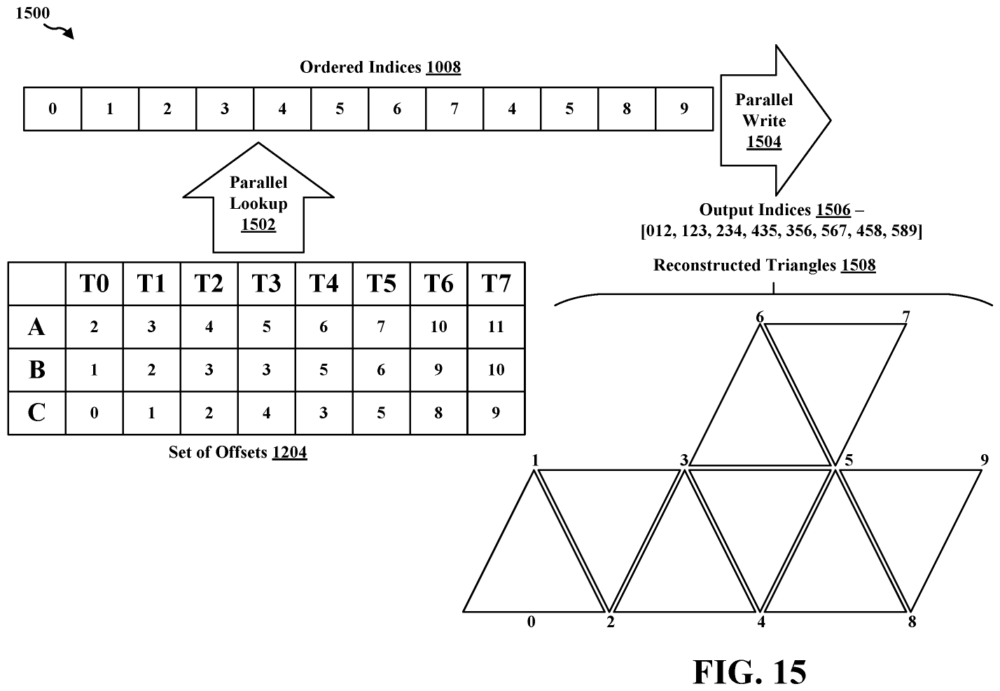

FIG. 15 is a diagram 1500 illustrating various example aspects of generating reconstructed triangles 1508 from the set of offsets 1204 and the ordered indices 1008. The reconstructed triangles 1508 may be generated as part of a topology decompression process (lossless) for a 3D mesh (e.g., the 3D mesh 402). A decoder (e.g., a GPU) may generate the set of offsets 1204 and the ordered indices 1008 as described above in the description of FIGS. 10-14. The decoder may perform a parallel lookup procedure 1502 with respect to the ordered indices 1008 using the set of offsets 1204 (e.g., the first offsets 1202, the second offsets 1302, and the third offsets 1402). The decoder may perform a parallel write procedure 1504 to generate output indices 1506 for the reconstructed triangles 1508. The output indices 1506 and the reconstructed triangles 1508 may correspond to the vertex indices 502 and the triangles 504, respectively. In order to reconstruct a correct winding of the triangles, i.e., the ordering of indices describing each triangle in the vertex indices 502, the decoder may reverse the alternating clockwise, counter-clockwise traversal used to encode triangle strips, also taking into account swap and restart indices which indicate: when the alternating index traversal rule in the output indices 1506 is broken, and when the restart dictates reset in traversal ordering, respectively. In an example, a GPU may render the reconstructed triangles 1508 using the output indices 1506 and the reconstructed triangles 1508 may be displayed on a display.

Examples of the parallel lookup procedure 1502 and the parallel write procedure 1504 for selected triangles are now set forth. For TO, the decoder may obtain an offset of “0” from C:T0. Based on the offset of “0,” the decoder may look up an integer (i.e., an index of a triangle) at the zero index in the ordered indices 1008. In the diagram 1500, the zero index in the ordered indices 1008 includes a “0.” The decoder may obtain an offset of “1” from B:T0. Based on the offset of “1,” the decoder may look up an integer (i.e., an index of a triangle) at the first index in the ordered indices 1008. In the diagram 1500, the first index in the ordered indices 1008 includes a “1.” The decoder may obtain an offset of “2” from A:T0. Based on the offset of “2,” the decoder may look up an integer (i.e., an index of a triangle) at the second index in the ordered indices 1008. In the diagram 1500, the second index in the ordered indices includes a “2.” The encoder may then write a [012] entry into the output indices 1506, where [012] corresponds to a triangle in the reconstructed triangles 1508.

For T6, the decoder may obtain an offset of “8” from C:T6. Based on the offset of “8,” the decoder may look up an integer (i.e., an index of a triangle) at the eighth index in the ordered indices 1008. In the diagram 1500, the eighth index in the ordered indices 1008 includes a “4.” The decoder may obtain an offset of “9” from B:T6. Based on the offset of “9,” the decoder may look up an integer (i.e., an index of a triangle) at the ninth index in the ordered indices 1008. In the diagram 1500, the ninth index in the ordered indices includes a “5.” The decoder may obtain an offset of “10” from A:T6. Based on the offset of “10,” the decoder may look up an integer (i.e., an index of a triangle) at the tenth index in the ordered indices 1008. In the diagram 1500, the tenth index in the ordered indices 1008 includes a “8.” The encoder may then write a [458] entry into the output indices 1506, where [458] corresponds to a triangle in the reconstructed triangles 1508.

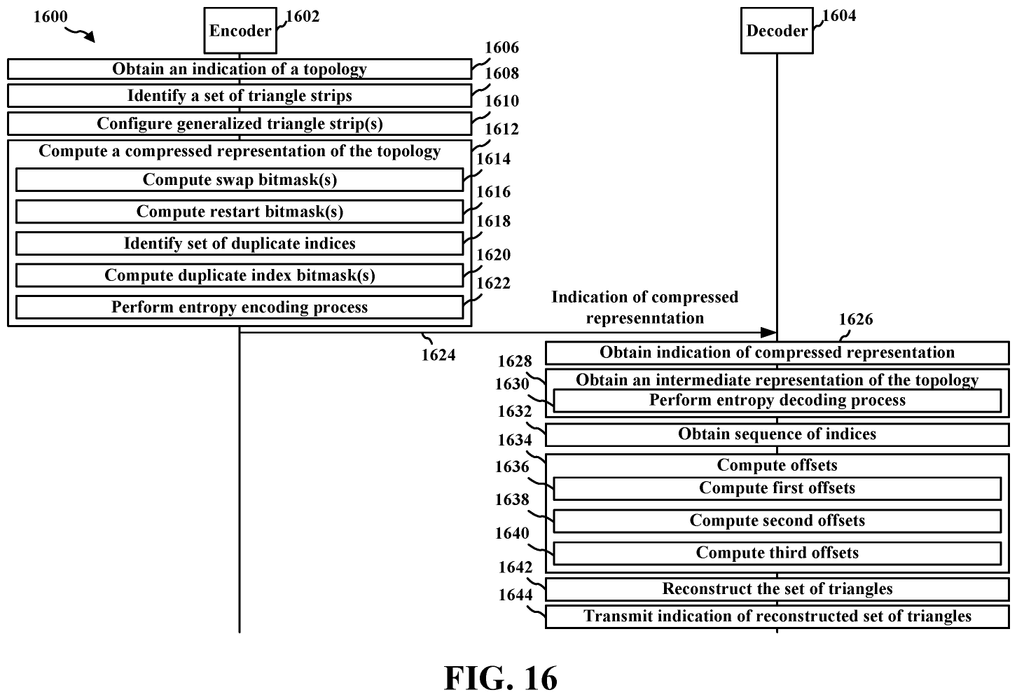

FIG. 16 is a call flow diagram 1600 illustrating example communications between an encoder 1602 and a decoder 1604 in accordance with one or more techniques of this disclosure. In an example, the encoder 1602 may be or include a CPU (or CPUs) and the decoder 1604 may be or include a graphics processor (or graphics processors).

At 1606, the encoder 1602 may obtain an indication of a topology associated with a mesh of a set of triangles. In an example, the indication of the topology may include the vertex indices 502 and/or the triangle strip associated list 601. At 1608, the encoder 1602 may identify a set of triangle strips corresponding to the topology associated with the mesh. At 1610, the encoder 1602 may configure at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip.

At 1612, the encoder 1602 may compute a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles. For instance, at 1614, the encoder 1602 may compute the at least one swap bitmask based on the at least one generalized triangle strip. For instance, at 1616, the encoder 1602 may compute the at least one restart bitmask based on the at least one generalized triangle strip. For instance, at 1618, the encoder 1602 may identify the set of duplicate indices in the sequence of indices. For instance, at 1620, the encoder 1602 may compute the at least one duplicate index bitmask based on the set of duplicate indices and the sequence of indices. For instance, at 1622, the encoder 1602 may perform an entropy encoding process on a numerical representation of at least one of: the set of duplicate indices in the sequence of indices, the at least one duplicate index bitmask corresponding to the set of duplicate indices, the at least one restart bitmask associated with the subset of triangles, or the at least one swap bitmask associated with the subset of triangles. An encoding process may refer to a process of modifying a representation of data in order to reduce a size of the representation. At 1624, the encoder 1602 may output an indication of the compressed representation. For instance, the encoder 1602 may transmit the indication of the compressed representation to the decoder 1604.

At 1626, the decoder 1604 may obtain the indication of the compressed representation of the topology. At 1628, the decoder 1604 may obtain an intermediate representation of the topology associated with the at least one generalized triangle strip by decompressing the compressed representation. For instance, at 1630, the decoder 1604 may perform an entropy decoding process for the compressed representation of the topology. A decoding process may refer to a process of restoring an original (or nearly original) representation of data from an encoded representation of the data. At 1632, the decoder 1604 may obtain the sequence of indices based on the intermediate representation of the topology associated with the at least one generalized triangle strip. At 1634, the decoder 1604 may compute at least one set of offsets based on the intermediate representation of the topology associated with the at least one generalized triangle strip. For instance, at 1636, the decoder 1604 may compute a first set of offsets based on the at least one restart bitmask. For instance, at 1638, the decoder 1604 may compute a second set of offsets based on the at least one swap bitmask and the first set of offsets. For instance, at 1640, the decoder 1604 may compute a third set of offsets based on at least one of: the at least one restart bitmask and the first set of offsets, the at least one swap bitmask and the first set of offsets, or the at least one swap bitmask and the second set of offsets. At 1642, the decoder 1604 may reconstruct the set of triangles based on the sequence of indices and the at least one set of offsets, where the reconstructed set of triangles corresponds to a mesh of the set of triangles. At 1644, the decoder 1604 may transmit an indication of the reconstructed set of triangles.

The above-described technologies may be associated with various technical advantages. For instance, the above-described technologies may lead to an imperceptible loss of quality in a reconstructed mesh geometry while still utilizing lossy compression. In an example, the above-described technologies may reduce appearances of artifacts (e.g., cracks) in the reconstructed mesh. Furthermore, the above-described technologies may be utilized to compress and/or decompress general manifold meshes without pre-processing the general meshes into representations suitable for a specific compression method. The above-described technologies may be associated with a lossless compression scheme associated with mesh topology information, which may be suitable for a parallel decoding algorithm (e.g., as described above in connection with FIGS. 10-15) that may be executed on a GPU. The parallel decoding algorithm may lead to real-time decoding and/or on-the-fly consumption of content. In one example, the parallel decoding algorithm may utilize inline decoding to provide for efficient decoding. In another example, the parallel decoding algorithm may utilize 2-pass decoding to provide for increased flexibility. The above-described technologies may also be associated with an encoder that may execute in a more rapid manner than other encoders. The above-described technologies may be associated with a single-rate mesh codec that may operate in real-time and that may achieve relatively low compression ratios for small meshes. In one example, the above-described technologies may be associated with a decoder that operates on a GPU using GPU memory. The decoder may decode content in real-time (e.g., less than 2 ms) with relatively little overhead.

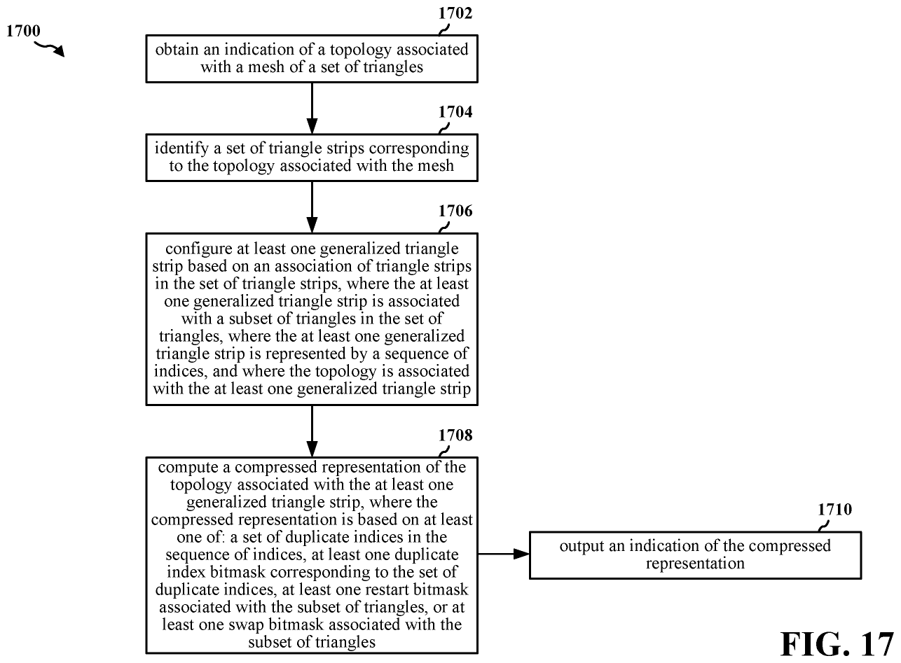

FIG. 17 is a flowchart 1700 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-16. In another example, the method may be performed by an encoder (e.g., the encoder 1602). The method may be associated with various technical advantages, such as reduced sizes for encoded content (e.g., topology). In an example, the method may be performed by the encoder/decoder 198.

At 1702, the apparatus obtains an indication of a topology associated with a mesh of a set of triangles. For example, FIG. 16 at 1606 shows that the encoder 1602 may obtain an indication of a topology associated with a mesh of a set of triangles. The topology may include aspects described above in the description of FIG. 4. In an example, 1702 may be performed by the encoder/decoder 198.

At 1704, the apparatus identifies a set of triangle strips corresponding to the topology associated with the mesh. For example, FIG. 16 at 1608 shows that the encoder 1602 may identify a set of triangle strips corresponding to the topology associated with the mesh. The set of triangle strips may include the first triangle strip 604, the second triangle strips 606, and/or the third triangle strip 608. In an example, 1704 may be performed by the encoder/decoder 198.

At 1706, the apparatus configures at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip. For example, FIG. 16 at 1610 shows that the encoder 1602 may configure at least one generalized triangle strip based on an association of triangle strips in the set of triangle strips. In an example, the at least one generalized triangle strip may be associated with aspects described above in FIGS. 7 and 8. In an example, the at least one generalized triangle strip may be or include the first intermediate triangle strip 704 and the second intermediate triangle strip 706. In an example, 1706 may be performed by the encoder/decoder 198.

At 1708, the apparatus computes a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles. For example, FIG. 16 at 1612 shows that the encoder 1602 may compute a compressed representation of the topology associated with the at least one generalized triangle strip. In an example, the set of duplicate indices may be or include the duplicate indices 904, the at least one duplicate index bitmask may be or include the duplicate index bitmask 906, the at least one restart bitmask may be or include the restart bitmask 810, and the at least one swap bitmask may be or include the swap bitmask 712. In an example, 1708 may be performed by the encoder/decoder 198.

At 1710, the apparatus outputs an indication of the compressed representation. For example, FIG. 16 at 1624 shows that the encoder 1602 may output an indication of the compressed representation. In an example, 1710 may be performed by the encoder/decoder 198.

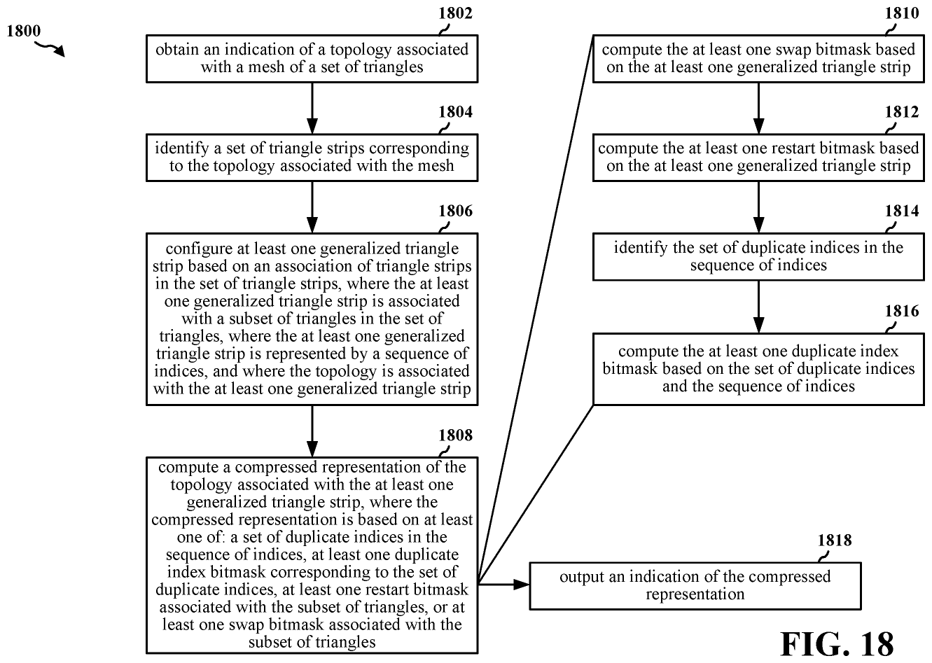

FIG. 18 is a flowchart 1800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-16. In another example, the method may be performed by an encoder (e.g., the encoder 1602). The method may be associated with various technical advantages, such as reduced sizes for encoded content (e.g., topology). In an example, the method (including the various aspects detailed below) may be performed by the encoder/decoder 198.

At 1802, the apparatus obtains an indication of a topology associated with a mesh of a set of triangles. For example, FIG. 16 at 1606 shows that the encoder 1602 may obtain an indication of a topology associated with a mesh of a set of triangles. The topology may include aspects described above in the description of FIG. 4. In an example, 1802 may be performed by the encoder/decoder 198.

At 1804, the apparatus identifies a set of triangle strips corresponding to the topology associated with the mesh. For example, FIG. 16 at 1608 shows that the encoder 1602 may identify a set of triangle strips corresponding to the topology associated with the mesh. The set of triangle strips may include the first triangle strip 604, the second triangle strips 606, and/or the third triangle strip 608. In an example, 1804 may be performed by the encoder/decoder 198.

At 1806, the apparatus configures at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip. For example, FIG. 16 at 1610 shows that the encoder 1602 may configure at least one generalized triangle strip based on an association of triangle strips in the set of triangle strips. In an example, the at least one generalized triangle strip may be associated with aspects described above in FIGS. 7 and 8. In an example, the at least one generalized triangle strip may be or include the first intermediate triangle strip 704 and the second intermediate triangle strip 706. In an example, 1806 may be performed by the encoder/decoder 198.

At 1808, the apparatus computes a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles. For example, FIG. 16 at 1612 shows that the encoder 1602 may compute a compressed representation of the topology associated with the at least one generalized triangle strip. In an example, the set of duplicate indices may be or include the duplicate indices 904, the at least one duplicate index bitmask may be or include the duplicate index bitmask 906, the at least one restart bitmask may be or include the restart bitmask 810, and the at least one swap bitmask may be or include the swap bitmask 712. In an example, 1808 may be performed by the encoder/decoder 198.

At 1818, the apparatus outputs an indication of the compressed representation. For example, FIG. 16 at 1624 shows that the encoder 1602 may output an indication of the compressed representation. In an example, 1818 may be performed by the encoder/decoder 198.

In one aspect, the at least one duplicate index bitmask may be indicative of positions in a reconstructed sequence of indices corresponding to duplicate indices in the set of duplicate indices, the at least one restart bitmask may be indicative of at least one first triangle in the set of triangles associated with the set of triangle strips, and the at least one swap bitmask may be indicative of a change of an index encoding direction of at least one second triangle in the subset of triangles. For example, the aforementioned aspects may include aspects described above in connection FIGS. 7-9.

In one aspect, at 1810, computing the compressed representation of the topology associated with the at least one generalized triangle strip may include: computing the at least one swap bitmask based on the at least one generalized triangle strip. For example, FIG. 16 at 1614 shows that the encoder 1602 may compute swap bitmask(s) based on generalized triangle strip(s). In an example, computing the at least one swap bitmask may include aspects described above in connection with FIG. 7. In an example, 1810 may be performed by the encoder/decoder 198.

In one aspect, at 1812, computing the compressed representation of the topology associated with the at least one generalized triangle strip may include: computing the at least one restart bitmask based on the at least one generalized triangle strip. For example, FIG. 16 at 1616 shows that the encoder 1602 may compute restart bitmask(s) based on the generalized triangle strip(s). In an example, computing the at least one restart bitmask may include aspects described above in connection with FIG. 8. In an example, 1812 may be performed by the encoder/decoder 198.

In one aspect, at 1814, computing the compressed representation of the topology associated with the at least one generalized triangle strip may include: identifying the set of duplicate indices in the sequence of indices. For example, FIG. 16 at 1618 shows that the encoder 1602 may identify a set of duplicate indices. Identifying the set of duplicate indices may include aspects described above in connection with FIG. 9. In an example, 1814 may be performed by the encoder/decoder 198.

In one aspect, at 1816, computing the compressed representation of the topology associated with the at least one generalized triangle strip may include: computing the at least one duplicate index bitmask based on the set of duplicate indices and the sequence of indices. For example, FIG. 16 at 1620 shows that the encoder 1602 may compute duplicate index bitmask(s). Computing the at least one duplicate index bitmask may include aspects described above in connection with FIG. 9. In an example, 1816 may be performed by the encoder/decoder 198.

In one aspect, outputting the indication of the compressed representation may include transmitting the indication of the compressed representation to a graphics processor. For example, FIG. 16 at 1624 shows that the encoder 1602 may transmit an indication of the compressed representation to the decoder 1604. The decoder 1604 may be a graphics processor.

In one aspect, the sequence of indices and the set of duplicate indices may include integer data. For example, the sequence of indices and the set of duplicate indices may include integer data.

In one aspect, computing the compressed representation of the topology may include performing an entropy encoding process on a numerical representation of at least one of: the set of duplicate indices in the sequence of indices, the at least one duplicate index bitmask corresponding to the set of duplicate indices, the at least one restart bitmask associated with the subset of triangles, or the at least one swap bitmask associated with the subset of triangles. For example, FIG. 16 at 1622 shows that the encoder 1602 may perform an entropy encoding process on a numerical representation of at least one of: the set of duplicate indices in the sequence of indices, the at least one duplicate index bitmask corresponding to the set of duplicate indices, the at least one restart bitmask associated with the subset of triangles, or the at least one swap bitmask associated with the subset of triangles.

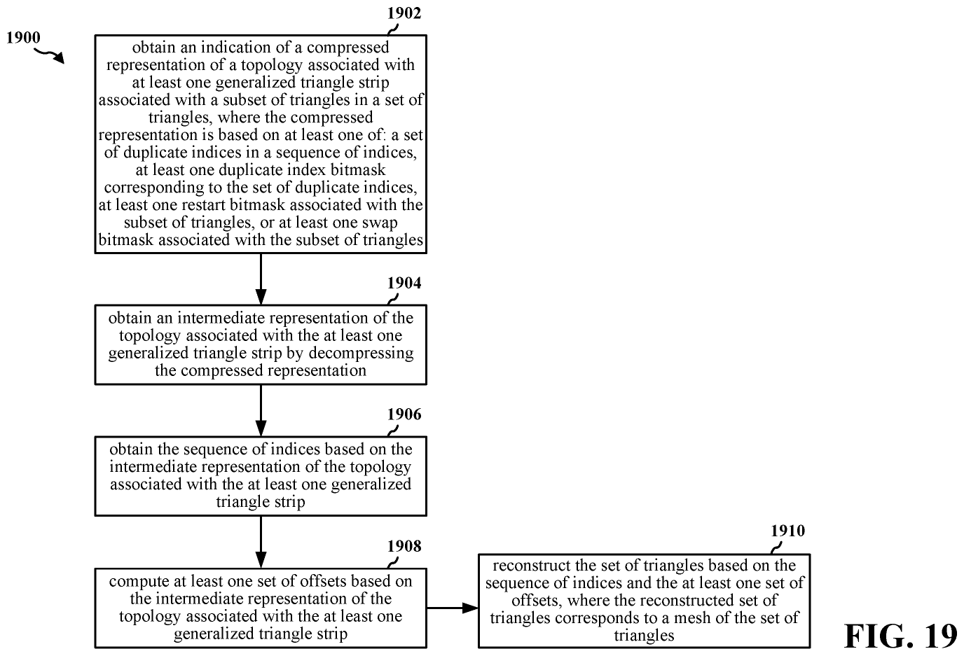

FIG. 19 is a flowchart 1900 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-16. In another example, the method may be performed by a decoder (e.g., the decoder 1604). The method may be associated with various technical advantages, such as reduced times for decoding content (e.g., topology). In an example, the method may be performed by the encoder/decoder 198.

At 1902, the apparatus obtains an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles. For example, FIG. 16 at 1626 shows that the decoder 1604 may obtain an indication of a compressed representation of a topology associated with at least one generalized triangle strip associated with a subset of triangles in a set of triangles. In an example, the set of duplicate indices may be or include the duplicate indices 904, the at least one duplicate index bitmask may be or include the duplicate index bitmask 906, the at least one restart bitmask may be or include the restart bitmask 810, and the at least one swap bitmask may be or include the swap bitmask 712. In an example, 1902 may be performed by the encoder/decoder 198.

At 1904, the apparatus obtains an intermediate representation of the topology associated with the at least one generalized triangle strip by decompressing the compressed representation. For example, FIG. 16 at 1628 shows that the decoder 1604 may obtain an intermediate representation of the topology associated with the at least one generalized triangle strip by decompressing the compressed representation. In an example, 1904 may be performed by the encoder/decoder 198.

At 1906, the apparatus obtains the sequence of indices based on the intermediate representation of the topology associated with the at least one generalized triangle strip. For example, FIG. 16 at 1632 shows that the decoder 1604 may obtain a sequence of indices based on the intermediate representation of the topology associated with the at least one generalized triangle strip. In an example, the sequence of indices may be or include the ordered indices 1008. In an example, 1906 may be performed by the encoder/decoder 198.

At 1908, the apparatus computes at least one set of offsets based on the intermediate representation of the topology associated with the at least one generalized triangle strip. For example, FIG. 16 at 1634 shows that that the decoder 1604 may compute offsets based on the intermediate representation of the topology associated with the at least one generalized triangle strip. In an example, the at least one set of offsets may be or include the set of offsets 1204. In an example, 1908 may be performed by the encoder/decoder 198.

At 1910, the apparatus reconstructs the set of triangles based on the sequence of indices and the at least one set of offsets, where the reconstructed set of triangles corresponds to a mesh of the set of triangles. For example, FIG. 16 at 1642 shows that the decoder 1604 may reconstruct the set of triangles based on the sequence of indices and the at least one set of offsets, where the reconstructed set of triangles corresponds to a mesh of the set of triangles. In an example, reconstructing the set of triangles may include aspects described above in connection with FIG. 15. In an example, 1910 may be performed by the encoder/decoder 198.

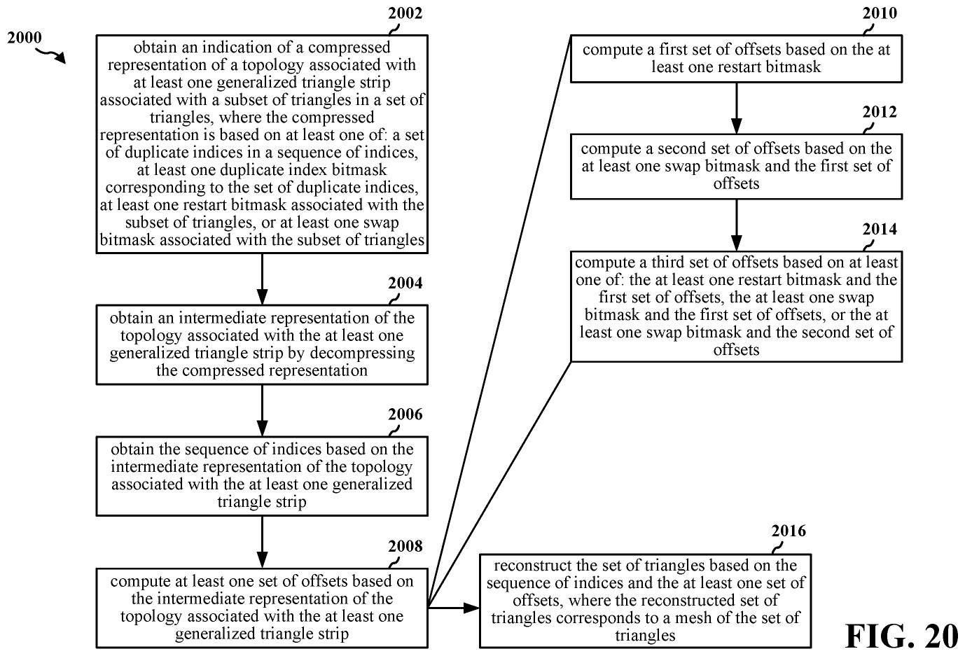

FIG. 20 is a flowchart 2000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-16. In another example, the method may be performed by a decoder (e.g., the decoder 1604). The method may be associated with various technical advantages, such as reduced times for decoding content (e.g., topology). In an example, the method (including the various aspects detailed below) may be performed by the encoder/decoder 198.

At 2002, the apparatus obtains an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles. For example, FIG. 16 at 1626 shows that the decoder 1604 may obtain an indication of a compressed representation of a topology associated with at least one generalized triangle strip associated with a subset of triangles in a set of triangles. In an example, the set of duplicate indices may be or include the duplicate indices 904, the at least one duplicate index bitmask may be or include the duplicate index bitmask 906, the at least one restart bitmask may be or include the restart bitmask 810, and the at least one swap bitmask may be or include the swap bitmask 712. In an example, 2002 may be performed by the encoder/decoder 198.

At 2004, the apparatus obtains an intermediate representation of the topology associated with the at least one generalized triangle strip by decompressing the compressed representation. For example, FIG. 16 at 1628 shows that the decoder 1604 may obtain an intermediate representation of the topology associated with the at least one generalized triangle strip by decompressing the compressed representation. In an example, 2004 may be performed by the encoder/decoder 198.

At 2006, the apparatus obtains the sequence of indices based on the intermediate representation of the topology associated with the at least one generalized triangle strip. For example, FIG. 16 at 1632 shows that the decoder 1604 may obtain a sequence of indices based on the intermediate representation of the topology associated with the at least one generalized triangle strip. In an example, the sequence of indices may be or include the ordered indices 1008. In an example, 2006 may be performed by the encoder/decoder 198.

At 2008, the apparatus computes at least one set of offsets based on the intermediate representation of the topology associated with the at least one generalized triangle strip. For example, FIG. 16 at 1634 shows that that the decoder 1604 may compute offsets based on the intermediate representation of the topology associated with the at least one generalized triangle strip. In an example, the at least one set of offsets may be or include the set of offsets 1204. In an example, 2008 may be performed by the encoder/decoder 198.

At 2016, the apparatus reconstructs the set of triangles based on the sequence of indices and the at least one set of offsets, where the reconstructed set of triangles corresponds to a mesh of the set of triangles. For example, FIG. 16 at 1642 shows that the decoder 1604 may reconstruct the set of triangles based on the sequence of indices and the at least one set of offsets, where the reconstructed set of triangles corresponds to a mesh of the set of triangles. In an example, reconstructing the set of triangles may include aspects described above in connection with FIG. 15. In an example, 2016 may be performed by the encoder/decoder 198.

In one aspect, the at least one duplicate index bitmask may be indicative of positions in the sequence of indices corresponding to duplicate indices in the set of duplicate indices, the at least one restart bitmask may be indicative of at least one first triangle in the set of triangles associated with a set of triangle strips associated with the mesh of the set of triangles, and the at least one swap bitmask may be indicative of a change of an index encoding direction of at least one second triangle in the subset of triangles. For example, the aforementioned aspects may include aspects described above in connection FIGS. 7-9.

In one aspect, at 2010, computing the at least one set of offsets may include: computing a first set of offsets based on the at least one restart bitmask. For example, FIG. 16 at 1636 shows that the decoder 1604 may compute first offsets based on the at least one restart bitmask. In an example, the first set of offsets may be or include the first offsets 1202. In an example, 2010 may be performed by the encoder/decoder 198.

In one aspect, at 2012, computing the at least one set of offsets may include: computing a second set of offsets based on the at least one swap bitmask and the first set of offsets. For example, FIG. 16 at 1638 shows that the decoder 1604 may compute second offsets based on the at least one swap bitmask and the first set of offsets. In an example, the second set of offsets may be or include the second offsets 1302. In an example, 2012 may be performed by the encoder/decoder 198.

In one aspect, at 2014, computing the at least one set of offsets may include: computing a third set of offsets based on at least one of: the at least one restart bitmask and the first set of offsets, the at least one swap bitmask and the first set of offsets, or the at least one swap bitmask and the second set of offsets. For example, FIG. 16 at 1640 shows that the decoder 1604 may compute third offsets. In an example, the third set of offsets may be or include the third offsets 1402. In an example, 2014 may be performed by the encoder/decoder 198.

In one aspect, reconstructing the set of triangles may include: selecting at least one first offset associated with at least one triangle in the set of triangles from the first set of offsets, at least one second offset associated with the at least one triangle in the set of triangles from the second set of offsets, and at least one third offset associated with the at least one triangle in the set of triangles from the third set of offsets. For example, selecting at least one first offset associated with at least one triangle in the set of triangles from the first set of offsets, at least one second offset associated with the at least one triangle in the set of triangles from the second set of offsets, and at least one third offset associated with the at least one triangle in the set of triangles from the third set of offsets may include aspects described above in connection FIG. 15.

In one aspect, reconstructing the set of triangles may include: identifying at least one first position, at least one second position, and at least one third position in the sequence of indices based on the at least one first offset, the at least one second offset, and the at least one third offset. For example, identifying at least one first position, at least one second position, and at least one third position in the sequence of indices based on the at least one first offset, the at least one second offset, and the at least one third offset may include aspects described above in connection with FIG. 15.

In one aspect, reconstructing the set of triangles may include: reading at least one first index in the at least one first position, at least one second index in the at least one second position, and at least one third index in the at least one third position of the sequence of indices, where the reconstructed set of triangles includes the at least one first index, the at least one second index, and the at least one third index. For example, reading at least one first index in the at least one first position, at least one second index in the at least one second position, and at least one third index in the at least one third position of the sequence of indices, where the reconstructed set of triangles includes the at least one first index, the at least one second index, and the at least one third index may include aspects described above in connection with FIG. 15.

In one aspect, each of a plurality of threads respectively may reconstruct each triangle in the set of triangles based on the sequence of indices and the at least one set of offsets. For example, the plurality of threads may be or include plurality of threads 1102-1116.

In one aspect, obtaining the indication of the compressed representation of the topology associated with the mesh of the set of triangles may include receiving the compressed representation from a central processing unit (CPU). For example, FIG. 16 at 1626 shows that the decoder 1604 may obtain the indication of the compressed representation of the topology from the encoder 1602, and the encoder 1602 may be a CPU.

In one aspect, the sequence of indices may include integer data. For example, the sequence of indices may include integer data.

In one aspect, obtaining the intermediate representation of the topology associated with the at least one generalized triangle strip by decompressing the compressed representation may include performing an entropy decoding process for the compressed representation of the topology associated with the at least one generalized triangle strip. For example, FIG. 16 at 1630 shows that the decoder 1604 may perform an entropy decoding process for the compressed representation of the topology associated with the at least one generalized triangle strip.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining an indication of a topology associated with a mesh of a set of triangles. The apparatus may include means for identifying a set of triangle strips corresponding to the topology associated with the mesh. The apparatus may include means for configuring at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip. The apparatus may include means for computing a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles. The apparatus may include means for outputting an indication of the compressed representation. The apparatus may include means for obtaining an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles. The apparatus may include means for obtaining an intermediate representation of the topology associated with the at least one generalized triangle strip by decompressing the compressed representation. The apparatus may include means for obtaining the sequence of indices based on the intermediate representation of the topology associated with the at least one generalized triangle strip. The apparatus may include means for computing at least one set of offsets based on the intermediate representation of the topology associated with the at least one generalized triangle strip. The apparatus may include means for reconstructing the set of triangles based on the sequence of indices and the at least one set of offsets, where the reconstructed set of triangles corresponds to a mesh of the set of triangles.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including: obtaining an indication of a topology associated with a mesh of a set of triangles; identifying a set of triangle strips corresponding to the topology associated with the mesh; configuring at least one generalized triangle strip based on an association of triangle strips in the set of triangle strips, where the at least one generalized triangle strip is associated with a subset of triangles in the set of triangles, where the at least one generalized triangle strip is represented by a sequence of indices, and where the topology is associated with the at least one generalized triangle strip; computing a compressed representation of the topology associated with the at least one generalized triangle strip, where the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles; and outputting an indication of the compressed representation.

Aspect 2 may be combined with aspect 1 and includes that the at least one duplicate index bitmask is indicative of positions in a reconstructed sequence of indices corresponding to duplicate indices in the set of duplicate indices, where the at least one restart bitmask is indicative of at least one first triangle in the set of triangles associated with the set of triangle strips, and where the at least one swap bitmask is indicative of a change of an index encoding direction of at least one second triangle in the subset of triangles.

Aspect 3 may be combined with aspect 2 and includes that computing the compressed representation of the topology associated with the at least one generalized triangle strip includes: computing the at least one swap bitmask based on the at least one generalized triangle strip.

Aspect 4 may be combined with any of aspects 2-3 and includes that computing the compressed representation of the topology associated with the at least one generalized triangle strip includes: computing the at least one restart bitmask based on the at least one generalized triangle strip.

Aspect 5 may be combined with any of aspects 1-4 and includes that computing the compressed representation of the topology associated with the at least one generalized triangle strip includes: identifying the set of duplicate indices in the sequence of indices; and computing the at least one duplicate index bitmask based on the set of duplicate indices and the sequence of indices.

Aspect 6 may be combined with any of aspects 1-5 and includes that outputting the indication of the compressed representation includes transmitting the indication of the compressed representation to a graphics processor.

Aspect 7 may be combined with any of aspects 1-6 and includes that the sequence of indices and the set of duplicate indices include integer data.

Aspect 8 may be combined with any of aspects 1-7 and includes that computing the compressed representation of the topology includes performing an entropy encoding process on a numerical representation of at least one of: the set of duplicate indices in the sequence of indices, the at least one duplicate index bitmask corresponding to the set of duplicate indices, the at least one restart bitmask associated with the subset of triangles, or the at least one swap bitmask associated with the subset of triangles.

Aspect 9 is an apparatus for graphics processing including at least one processor coupled to a memory and configured to implement a method as in any of aspects 1-8.

Aspect 10 may be combined with aspect 9 and includes that the apparatus is a wireless communication device including at least one of a transceiver or an antenna coupled to the at least one processor, and to obtain the indication of the topology, the at least one processor is configured to obtain the indication of the topology via at least one of the transceiver or the antenna.

Aspect 11 is an apparatus for graphics processing including means for implementing a method as in any of aspects 1-9.

Aspect 12 is a computer-readable medium (e.g., a non-transitory computer-readable medium) storing computer executable code, the computer executable code when executed by at least one processor causes the at least one processor to implement a method as in any of aspects 1-9.

Aspect 13 is a method of graphics processing, including: obtaining an indication of a compressed representation of a topology associated with at least one generalized triangle strip associated with a subset of triangles in a set of triangles, where the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles; obtaining an intermediate representation of the topology associated with the at least one generalized triangle strip by decompressing the compressed representation; obtaining the sequence of indices based on the intermediate representation of the topology associated with the at least one generalized triangle strip; computing at least one set of offsets based on the intermediate representation of the topology associated with the at least one generalized triangle strip; and reconstructing the set of triangles based on the sequence of indices and the at least one set of offsets, where the reconstructed set of triangles corresponds to a mesh of the set of triangles.

Aspect 14 may be combined with aspect 13 and includes that the at least one duplicate index bitmask is indicative of positions in the sequence of indices corresponding to duplicate indices in the set of duplicate indices, where the at least one restart bitmask is indicative of at least one first triangle in the set of triangles associated with a set of triangle strips associated with the mesh of the set of triangles, and where the at least one swap bitmask is indicative of a change of an index encoding direction of at least one second triangle in the subset of triangles.

Aspect 15 may be combined with any of aspects 13-14 and includes that computing the at least one set of offsets includes: computing a first set of offsets based on the at least one restart bitmask.

Aspect 16 may be combined with aspect 15 and includes that computing the at least one set of offsets includes: computing a second set of offsets based on the at least one swap bitmask and the first set of offsets.

Aspect 17 may be combined with aspect 16 and includes that computing the at least one set of offsets includes: computing a third set of offsets based on at least one of: the at least one restart bitmask and the first set of offsets, the at least one swap bitmask and the first set of offsets, or the at least one swap bitmask and the second set of offsets.

Aspect 18 may be combined with aspect 17 and includes that reconstructing the set of triangles includes: selecting at least one first offset associated with at least one triangle in the set of triangles from the first set of offsets, at least one second offset associated with the at least one triangle in the set of triangles from the second set of offsets, and at least one third offset associated with the at least one triangle in the set of triangles from the third set of offsets; identifying at least one first position, at least one second position, and at least one third position in the sequence of indices based on the at least one first offset, the at least one second offset, and the at least one third offset; and reading at least one first index in the at least one first position, at least one second index in the at least one second position, and at least one third index in the at least one third position of the sequence of indices, where the reconstructed set of triangles includes the at least one first index, the at least one second index, and the at least one third index.

Aspect 19 may be combined with any of aspects 14-18 and includes that each of a plurality of threads respectively reconstructs each triangle in the set of triangles based on the sequence of indices and the at least one set of offsets.

Aspect 20 may be combined with any of aspects 14-19 and includes that obtaining the indication of the compressed representation of the topology associated with the mesh of the set of triangles includes receiving the compressed representation from a central processing unit (CPU).

Aspect 21 may be combined with any of aspects 14-20 and includes that the sequence of indices includes integer data.

Aspect 22 may be combined with any of aspects 13-21 and includes that obtaining the intermediate representation of the topology associated with the at least one generalized triangle strip by decompressing the compressed representation includes performing an entropy decoding process for the compressed representation of the topology associated with the at least one generalized triangle strip.

Aspect 23 is an apparatus for graphics processing including at least one processor coupled to a memory and configured to implement a method as in any of aspects 13-22.

Aspect 24 may be combined with aspect 23 and includes that the apparatus is a wireless communication device including at least one of a transceiver or an antenna coupled to the at least one processor, and to obtain the indication of the compressed representation of the topology, the at least one processor is configured to obtain the indication of the compressed representation of the topology via at least one of the transceiver or the antenna.

Aspect 25 is an apparatus for graphics processing including means for implementing a method as in any of aspects 13-22.

Aspect 26 is a computer-readable medium (e.g., a non-transitory computer-readable medium) storing computer executable code, the computer executable code when executed by at least one processor causes the at least one processor to implement a method as in any of aspects 13-22.

Various aspects have been described herein. These and other aspects are within the scope of the following claims.

What is claimed is:

1. An apparatus for graphics processing, comprising:
a memory; and
at least one processor coupled to the memory and, based at least in part on information stored in the memory, the at least one processor is configured to:
obtain an indication of a topology associated with a mesh of a set of triangles;
identify a set of triangle strips corresponding to the topology associated with the mesh;
configure at least one generalized triangle strip based on an association of triangle strips in the set of triangle strips, wherein the at least one generalized triangle strip is associated with a subset of triangles in the set of triangles, wherein the at least one generalized triangle strip is represented by a sequence of indices, and wherein the topology is associated with the at least one generalized triangle strip;
compute a compressed representation of the topology associated with the at least one generalized triangle strip, wherein the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles; and
output an indication of the compressed representation.

2. The apparatus of claim 1, wherein the at least one duplicate index bitmask is indicative of positions in a reconstructed sequence of indices corresponding to duplicate indices in the set of duplicate indices, wherein the at least one restart bitmask is indicative of at least one first triangle in the set of triangles associated with the set of triangle strips, and wherein the at least one swap bitmask is indicative of a change of an index encoding direction of at least one second triangle in the subset of triangles.

3. The apparatus of claim 2, wherein to compute the compressed representation of the topology associated with the at least one generalized triangle strip, the at least one processor is configured to:
compute the at least one swap bitmask based on the at least one generalized triangle strip.

4. The apparatus of claim 2, wherein to compute the compressed representation of the topology associated with the at least one generalized triangle strip, the at least one processor is configured to:
compute the at least one restart bitmask based on the at least one generalized triangle strip.

5. The apparatus of claim 1, wherein to compute the compressed representation of the topology associated with the at least one generalized triangle strip, the at least one processor is configured to:
identify the set of duplicate indices in the sequence of indices; and
compute the at least one duplicate index bitmask based on the set of duplicate indices and the sequence of indices.

6. The apparatus of claim 1, wherein to output the indication of the compressed representation of the topology associated with the at least one generalized triangle strip, the at least one processor is configured to transmit the indication of the compressed representation to a graphics processor.

7. The apparatus of claim 1, wherein the sequence of indices and the set of duplicate indices comprise integer data.

8. The apparatus of claim 1, wherein to compute the compressed representation of the topology associated with the at least one generalized triangle strip, the at least one processor is configured to:
perform an entropy encoding process on a numerical representation of at least one of: the set of duplicate indices in the sequence of indices, the at least one duplicate index bitmask corresponding to the set of duplicate indices, the at least one restart bitmask associated with the subset of triangles, or the at least one swap bitmask associated with the subset of triangles.

9. The apparatus of claim 1, wherein the apparatus is a wireless communication device comprising at least one of a transceiver or an antenna coupled to the at least one processor, wherein to obtain the indication of the topology, the at least one processor is configured to obtain the indication of the topology via at least one of the transceiver or the antenna.

10. An apparatus for graphics processing, comprising:
a memory; and
at least one processor coupled to the memory and, based at least in part on information stored in the memory, the at least one processor is configured to:
obtain an indication of a compressed representation of a topology associated with at least one generalized triangle strip associated with a subset of triangles in a set of triangles, wherein the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles;
obtain an intermediate representation of the topology associated with the at least one generalized triangle strip by a decompression of the compressed representation;
obtain the sequence of indices based on the intermediate representation of the topology associated with the at least one generalized triangle strip;
compute at least one set of offsets based on the intermediate representation of the topology associated with the at least one generalized triangle strip; and
reconstruct the set of triangles based on the sequence of indices and the at least one set of offsets, wherein the reconstructed set of triangles corresponds to a mesh of the set of triangles.

11. The apparatus of claim 10, wherein the at least one duplicate index bitmask is indicative of positions in the sequence of indices corresponding to duplicate indices in the set of duplicate indices, wherein the at least one restart bitmask is indicative of at least one first triangle in the set of triangles associated with a set of triangle strips associated with the mesh of the set of triangles, and wherein the at least one swap bitmask is indicative of a change of an index encoding direction of at least one second triangle in the subset of triangles.

12. The apparatus of claim 10, wherein to compute the at least one set of offsets, the at least one processor is configured to:
compute a first set of offsets based on the at least one restart bitmask.

13. The apparatus of claim 12, wherein to compute the at least one set of offsets, the at least one processor is configured to:
compute a second set of offsets based on the at least one swap bitmask and the first set of offsets.

14. The apparatus of claim 13, wherein to compute the at least one set of offsets, the at least one processor is configured to:
compute a third set of offsets based on at least one of:
the at least one restart bitmask and the first set of offsets,
the at least one swap bitmask and the first set of offsets, or
the at least one swap bitmask and the second set of offsets.

15. The apparatus of claim 14, wherein to reconstruct the set of triangles, the at least one processor is configured to:
select at least one first offset associated with at least one triangle in the set of triangles from the first set of offsets, at least one second offset associated with the at least one triangle in the set of triangles from the second set of offsets, and at least one third offset associated with the at least one triangle in the set of triangles from the third set of offsets;
identify at least one first position, at least one second position, and at least one third position in the sequence of indices based on the at least one first offset, the at least one second offset, and the at least one third offset; and
read at least one first index in the at least one first position, at least one second index in the at least one second position, and at least one third index in the at least one third position of the sequence of indices, wherein the reconstructed set of triangles includes the at least one first index, the at least one second index, and the at least one third index.

16. The apparatus of claim 11, wherein to reconstruct the set of triangles based on the sequence of indices and the at least one set of offsets, the at least one processor is configured to:
reconstruct the set of triangles via a plurality of threads based on the sequence of indices and the at least one set of offsets, wherein each thread in the plurality of threads respectively reconstructs each triangle in the set of triangles.

17. The apparatus of claim 11, wherein to obtain the indication of the compressed representation of the topology associated with the mesh of the set of triangles, the at least one processor is configured to:
receive the compressed representation from a central processing unit (CPU).

18. The apparatus of claim 11, wherein the sequence of indices and the set of duplicate indices comprise integer data.

19. The apparatus of claim 10, wherein to obtain the intermediate representation of the topology associated with the at least one generalized triangle strip by the decompression of the compressed representation, the at least one processor is configured to:
perform an entropy decoding process for the compressed representation of the topology associated with the at least one generalized triangle strip.

20. The apparatus of claim 10, wherein the apparatus is a wireless communication device comprising at least one of a transceiver or an antenna coupled to the at least one processor, wherein to obtain the indication of the compressed representation of the topology, the at least one processor is configured to obtain the compression representation of the topology via at least one of the transceiver or the antenna.

21. A method of graphics processing, comprising:
obtaining an indication of a topology associated with a mesh of a set of triangles;
identifying a set of triangle strips corresponding to the topology associated with the mesh;
configuring at least one generalized triangle strip based on an association of triangle strips in the set of triangle strips, wherein the at least one generalized triangle strip is associated with a subset of triangles in the set of triangles, wherein the at least one generalized triangle strip is represented by a sequence of indices, and wherein the topology is associated with the at least one generalized triangle strip;
computing a compressed representation of the topology associated with the at least one generalized triangle strip, wherein the compressed representation is based on at least one of: a set of duplicate indices in the sequence of indices, at least one duplicate index bitmask corresponding to the set of duplicate indices, at least one restart bitmask associated with the subset of triangles, or at least one swap bitmask associated with the subset of triangles; and
outputting an indication of the compressed representation.

22. The method of claim 21, wherein the at least one duplicate index bitmask is indicative of positions in a reconstructed sequence of indices corresponding to duplicate indices in the set of duplicate indices, wherein the at least one restart bitmask is indicative of at least one first triangle in the set of triangles associated with the set of triangle strips, and wherein the at least one swap bitmask is indicative of a change of an index encoding direction of at least one second triangle in the subset of triangles.

23. The method of claim 22, wherein computing the compressed representation of the topology associated with the at least one generalized triangle strip comprises:
computing the at least one swap bitmask based on the at least one generalized triangle strip.

24. The method of claim 22, wherein computing the compressed representation of the topology associated with the at least one generalized triangle strip comprises:
computing the at least one restart bitmask based on the at least one generalized triangle strip.

25. The method of claim 21, wherein computing the compressed representation of the topology associated with the at least one generalized triangle strip comprises:
identifying the set of duplicate indices in the sequence of indices; and
computing the at least one duplicate index bitmask based on the set of duplicate indices and the sequence of indices.

26. A method of graphics processing, comprising:
obtaining an indication of a compressed representation of a topology associated with at least one generalized triangle strip associated with a subset of triangles in a set of triangles, wherein the compressed representation is based on at least one of: a set of duplicate indices in a sequence of indices, at least one duplicate index bitmask corresponding to the set of duplicate indices, at least one restart bitmask associated with the subset of triangles, or at least one swap bitmask associated with the subset of triangles;
obtaining an intermediate representation of the topology associated with the at least one generalized triangle strip by decompressing the compressed representation;
obtaining the sequence of indices based on the intermediate representation of the topology associated with the at least one generalized triangle strip;
computing at least one set of offsets based on the intermediate representation of the topology associated with the at least one generalized triangle strip; and
reconstructing the set of triangles based on the sequence of indices and the at least one set of offsets, wherein the reconstructed set of triangles corresponds to a mesh of the set of triangles.

27. The method of claim 26, wherein the at least one duplicate index bitmask is indicative of positions in the sequence of indices corresponding to duplicate indices in the set of duplicate indices, wherein the at least one restart bitmask is indicative of at least one first triangle in the set of triangles associated with a set of triangle strips associated with the mesh of the set of triangles, and wherein the at least one swap bitmask is indicative of a change of an index encoding direction of at least one second triangle in the subset of triangles.

28. The method of claim 26, wherein computing the at least one set of offsets comprises:
computing a first set of offsets based on the at least one restart bitmask.

29. The method of claim 28, wherein computing the at least one set of offsets comprises:
computing a second set of offsets based on the at least one swap bitmask and the first set of offsets.

30. The method of claim 29, wherein computing the at least one set of offsets comprises:
computing a third set of offsets based on at least one of:
the at least one restart bitmask and the first set of offsets,
the at least one swap bitmask and the first set of offsets, or
the at least one swap bitmask and the second set of offsets.
